(19) United States
(12) Patent Application Publication
(10) Pub. No.: US 2013/0111238 A1
(43) Pub. Date: May 2, 2013

(54) Image Processing System, Image Processing Apparatus, Portable Information Apparatus, Image Processing Apparatus Coordination Method, Portable Information Apparatus Coordination Method, Non-Transitory Computer-Readable Recording Medium Encoded with Image Processing Apparatus Coordination Program, and Non-Transitory Computer-Readable Recording Medium Encoded with Portable Information Apparatus Coordination Program

(71) Applicants: Kazusei TAKAHASHI, Nishinomiya-shi (JP); Katsuhiko AKITA, Amagasaki-shi (JP); Takeshi MORIKAWA, Takarazuka-shi (JP); Daisuke NAKANO, Kobe-shi (JP); Yuji OKAMOTO, Amagasaki-shi (JP)

(72) Inventors: Kazusei TAKAHASHI, Nishinomiya-shi (JP); Katsuhiko AKITA, Amagasaki-shi (JP); Takeshi MORIKAWA, Takarazuka-shi (JP); Daisuke NAKANO, Kobe-shi (JP); Yuji OKAMOTO, Amagasaki-shi (JP)

(73) Assignee: KONICA MINOLTA BUSINESS TECHNOLOGIES, INC., Tokyo (JP)

(21) Appl. No.: 13/659,957

(22) Filed: Oct. 25, 2012

(30) Foreign Application Priority Data
Nov. 2, 2011 (JP) 2011-241227

(51) Int. Cl. G06F 15/173; G06F 1/32

(52) U.S. Cl. 713/320

(57) ABSTRACT

In an image processing system that allows mutual remote operation with a client remotely operating one of an image processing apparatus and a portable information apparatus and with a server being remotely operated by the other, each of the image processing apparatus and the portable information apparatus includes a display portion to display an image, a switch portion to switch the display portion to a power saving mode in which power consumption is smaller than in a normal mode, when functioning as the server, and to switch the display portion to the normal mode, when functioning as a client, and a display control portion to simultaneously display a self-operation screen for operating the apparatus itself and a remote operation screen for remotely operating the server on the display portion, when functioning as the client.

This application is based on Japanese Patent Application No. 2011-241227 filed with Japan Patent Office on Nov. 2, 2011, the entire content of which is hereby incorporated by reference.

### BACKGROUND OF THE INVENTION

1. Field of the Invention

The present invention relates to an image processing system, an image processing apparatus, a portable information apparatus, an image processing apparatus coordination method, a portable information apparatus coordination method, a non-transitory computer-readable recording medium encoded with an image processing apparatus coordination program, and a non-transitory computer-readable recording medium encoded with a portable information apparatus coordination program. More specifically, the present invention relates to an image processing system including a portable information apparatus and an image processing apparatus, the image processing apparatus, the portable information apparatus, an image processing apparatus coordination method performed in the image processing apparatus and a non-transitory computer-readable recording medium encoded with an image processing apparatus coordination program, and a portable information apparatus coordination method performed in the portable information processing apparatus and a non-transitory computer-readable recording medium encoded with a portable information apparatus coordination program.

2. Description of the Related Art

In recent years, portable information apparatuses such as PDAs (Personal Digital Assistants) including electronic paper or smartphones can store documents in electronic format and enables viewing or editing of documents regardless of time and place. The document stored in a portable information apparatus can be transmitted to an image processing apparatus such as a Multi-Functional Peripheral (hereinafter referred to as “MFP”) to allow the image processing apparatus to perform print, saving, or any other processing. However, this requires that the portable information apparatus and the image processing apparatus should be operated separately, thereby complicating the operation.

Japanese Patent Laid-Open No. 2010-187226 discloses an image processing system including a printer at least having a first operation panel for displaying its own information, a scanner having a second operation panel for displaying its own information, an acquisition unit for acquiring information about a display function, a select unit for selecting the first operation panel or the second operation panel in accordance with the acquisition result, and a control unit for controlling display of information about each device as display means shared with the first operation panel or the second operation panel as selected by the select unit.

The conventional image processing system uses, for example, the operation panel of the printer in place of the operation panel of the scanner, so that the scanner can be operated using the operation panel of the printer. However, when the printer is to be operated on the operation panel of the printer, the operation panel of the printer has to be used. Therefore, although the printer and the scanner can be operated with a signal operation panel, the operation screen of only one of the printer and the scanner can be displayed at a time. An operation of switching the screens is thus required, thereby complicating the operation.

### SUMMARY OF THE INVENTION

In order to achieve the object above, according to an aspect of the present invention, an image processing system allows mutual remote operation with a client remotely operating one of an image processing apparatus and a portable information apparatus and with a server being remotely operated by the other. Each of the image processing apparatus and the portable information apparatus includes: a display portion to display an image; a switch portion to switch the display portion to a power saving mode in which power consumption is smaller than in a normal mode, when functioning as the server, and to switch the display portion to the normal mode, when functioning as the client; and a display control portion to simultaneously display a self-operation screen for operating the apparatus itself and a remote operation screen for remotely operating the server on the display portion, when functioning as the client.

According to another aspect of the present invention, an image processing apparatus includes: a display portion to display an image; a communication portion to communicate with a portable information apparatus; a server portion to communicate with the portable information apparatus and to function as a server being remotely operated by the portable information apparatus; a client portion to communicate with the portable information apparatus and to function as a client remotely operating the portable information apparatus; a switch portion to switch the display portion to a power saving mode in which power consumption is smaller than in a normal mode, when functioning as the server, and to switch the display portion to the normal mode, when functioning as the client; and a display control portion to simultaneously display a self-operation screen for operating the image processing apparatus itself and a remote operation screen for remotely operating the portable information apparatus on the display portion, when functioning as the client.

According to a further aspect of the present invention, a portable information apparatus includes: a display portion to display an image; a communication portion to communicate with an image processing apparatus; a server portion to communicate with the image processing apparatus and to function as a server being remotely operated by the image processing apparatus; a client portion to communicate with the image processing apparatus and to function as a client remotely operating the image processing apparatus; a switch portion to switch the display portion to a power saving mode in which power consumption is smaller than in a normal mode, when functioning as the server, and to switch the display portion to the normal mode, when functioning as the client; and a display control portion to simultaneously display a self-operation screen for operating the portable information apparatus itself and a remote operation screen for remotely operating the image processing apparatus on the display portion, when functioning as the client.

According to a still further aspect of the present invention, an image processing apparatus coordination method is performed in an image processing apparatus that coordinates with a portable information apparatus to accept an operation. The image processing apparatus includes a display portion to display an image, a communication portion to communicate with a portable information apparatus, a server portion to communicate with the portable information apparatus and to function as a server being remotely operated by the portable information apparatus, and a client portion to communicate with the portable information apparatus and to function as a client remotely operating the portable information apparatus. The method includes the steps of: when functioning as the server, switching the display portion to a power saving mode in which power consumption is smaller than in a normal mode; when functioning as the client, switching the display portion to the normal mode; and when functioning as the client, simultaneously displaying a self-operation screen for operating the image processing apparatus itself and a remote operation screen for remotely operating the portable information apparatus on the display portion.

According to yet another aspect of the present invention, a portable information apparatus coordination method is performed in a portable information apparatus that coordinates with an image processing apparatus to accept an operation. The portable information apparatus includes a display portion to display an image, a communication portion to communicate with an image processing apparatus, a server portion to communicate with the image processing apparatus and to function as a server being remotely operated by the image processing apparatus, and a client portion to communicate with the image processing apparatus and to function as a client remotely operating the image processing apparatus. The method includes the steps of: when functioning as the server, switching the display portion to a power saving mode in which power consumption is smaller than in a normal mode; when functioning as the client, switching the display portion to the normal mode; and when functioning as the client, simultaneously displaying a self-operation screen for operating the portable information apparatus itself and a remote operation screen for remotely operating the image processing apparatus on the display portion.

According to another aspect of the present invention, a non-transitory computer-readable recording medium is encoded with an image processing apparatus coordination program executed by a computer controlling an image processing apparatus that coordinates with a portable information apparatus to accept an operation. The image processing apparatus includes a display portion to display an image, a communication portion to communicate with a portable information apparatus, a server portion to communicate with the portable information apparatus and to function as a server being remotely operated by the portable information apparatus, and a client portion to communicate with the portable information apparatus and to function as a client remotely operating the portable information apparatus. The program causes the computer to perform processing including the steps of: when functioning as the server, switching the display portion to a power saving mode in which power consumption is smaller than in a normal mode; when functioning as the client, switching the display portion to the normal mode; and when functioning as the client, simultaneously displaying a self-operation screen for operating the image processing apparatus itself and a remote operation screen for remotely operating the portable information apparatus on the display portion.

According to a further aspect of the present invention, a non-transitory computer-readable recording medium is encoded with a portable information apparatus coordination program executed by a computer controlling a portable information apparatus that coordinates with an image processing apparatus to accept an operation. The portable information apparatus includes a display portion to display an image, a communication portion to communicate with an image processing apparatus, a server portion to communicate with the image processing apparatus and to function as a server being remotely operated by the image processing apparatus, and a client portion to communicate with the image processing apparatus and to function as a client remotely operating the image processing apparatus. The program causes the computer to perform processing including the steps of: when functioning as the server, switching the display portion to a power saving mode in which power consumption is smaller than in a normal mode; when functioning as the client, switching the display portion to the normal mode; and when functioning as the client, simultaneously displaying a self-operation screen for operating the portable information apparatus itself and a remote operation screen for remotely operating the image processing apparatus on the display portion.

The foregoing and other features, aspects, and advantages of the present invention will become more apparent from the following detailed description of the present invention when taken in conjunction with the accompanying drawings.

### BRIEF DESCRIPTION OF THE DRAWINGS

FIG. 1 is a diagram showing an overview of an image processing system in an embodiment of the present invention.

FIG. 2 is a block diagram showing an overall hardware configuration of an MFP.

FIG. 3 is a plan view showing an example of an operation panel.

FIG. 4 is a block diagram showing an overall hardware configuration of a portable information apparatus.

FIG. 5 is a diagram showing an example of functions of a CPU of the MFP.

FIG. 6 is a diagram showing an example of a coordination setting screen.

FIG. 7 is a diagram showing an example of functions of a CPU of the portable information apparatus.

FIG. 8 is a diagram showing an example of a screen appearing on the MFP functioning as a client.

FIG. 9 is a diagram showing an example of a screen appearing on the portable information apparatus functioning as a client.

FIG. 10 is a diagram showing an example of a copy-and-paste operation.

FIG. 11 is a diagram showing an example of a specific operation.

FIG. 12 is a diagram showing an example of a first alternative screen.

FIG. 13 is a diagram showing an example of a first specific operation screen.

FIG. 14 is a diagram showing an example of a second alternative screen.

FIG. 15 is a diagram showing an example of a second specific operation screen.

FIG. 16 is a flowchart showing an exemplary flow of an image processing apparatus coordination process.

FIG. 17 is a flowchart showing an exemplary flow of a first operation accepting process.

FIG. 18 is a flowchart showing an exemplary flow of a portable information apparatus coordination process.

FIG. 19 is a flowchart showing an exemplary flow of a second operation accepting process.

### DESCRIPTION OF THE PREFERRED EMBODIMENTS

Embodiments of the present invention will be described below with reference to the figures. In the following description, the same parts are denoted with the same reference numerals. Their names and functions are also the same. A detailed description thereof is therefore not repeated.

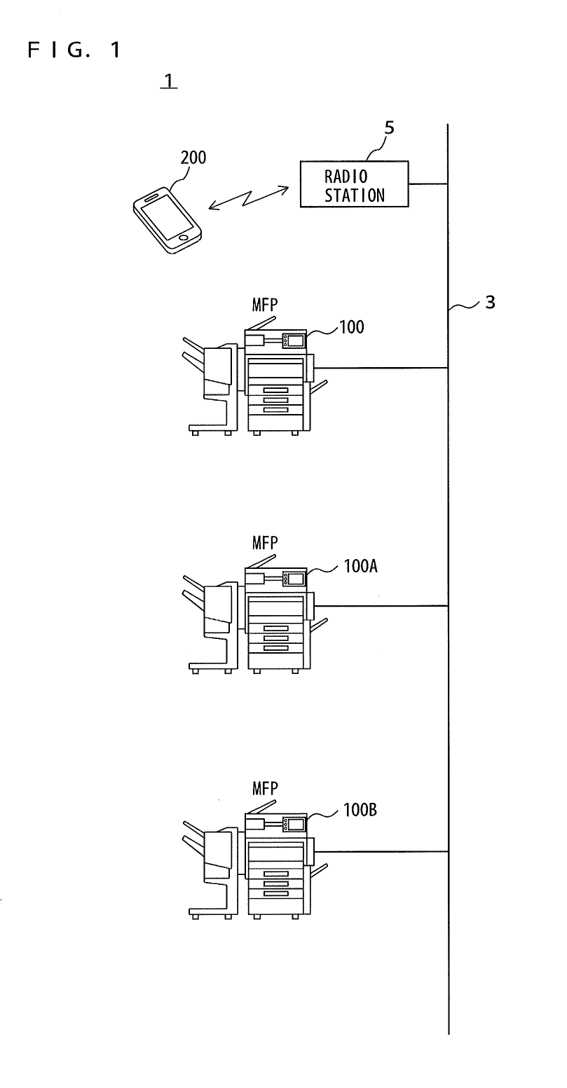

FIG. 1 is a diagram showing an overview of an image processing system in an embodiment of the present invention. Referring to FIG. 1, an image processing system 1 includes Multi-Functional Peripherals (hereinafter referred to as “MFPs”) 100, 100A, and 100B, a portable information apparatus 200, and a radio station 5, each connected to a network 3. Therefore, MFPs 100, 100A, and 100B can communication with each other via network 3.

In the figure, three MFPs 100, 100A, 100B are connected as image processing apparatuses to network 3, by way of example. However, the number of MFPs is not limited thereto as long as one or more MFPs are connected. MFPs 100, 100A, and 100B may be replaced with any other device having a function of processing data, for example, a computer, a facsimile, or a printer.

Network 3 is a Local Area Network (LAN), either wired or wireless. Network 3 is not limited to a LAN and may be a Wide Area Network (WAN), a network using a Public Switched Telephone Network, or the like. Network 3 is connected to the Internet. Therefore, MFPs 100, 100A, and 100B each can communicate with a computer such as a server connected to the Internet.

Portable information apparatus 200 is electronic paper or a PDA (Personal Digital Assistant) having a communication function, such as a smartphone. Here, portable information apparatus 200 is a smartphone, by way of example. Portable information apparatus 200 can wirelessly communicate with a base station for mobile phones to connect to a mobile phone network and establish a call. Portable information apparatus 200 has a wireless LAN function.

Radio station 5 is further connected to network 3. Radio station 5 is a relay apparatus of network 3 and communicates with portable information apparatus 200 having a wireless LAN communication function to connect portable information apparatus 200 to network 3. Therefore, portable information apparatus 200 can transmit/receive data to/from MFPs 100, 100A, and 100B connected to network 3.

In image processing system 1 in the present embodiment, portable information apparatus 200 and any one of MFPs 100, 100A, and 100B communicate with each other for transmission and reception of data. The protocol for transmitting/receiving data is not specifically limited, and any protocol can be used. Portable information apparatus 200 transmits data stored therein to any one of MFPs 100, 100A, and 100B to allow any one of MFPs 100, 100A, and 100B to save, display, transmit, or perform image processing on the data. Portable information apparatus 200 can receive data stored in any one of MFPs 100, 100A, and 100B to process the data, for example, save, display, or transmit the data. Data stored in portable information apparatus 200 or MFPs 100, 100A, 100B may be application data downloaded from a Personal Computer (PC) or the like connected to network 3 or may be data downloaded from a server connected to the Internet, if an internet browser program is installed in portable information apparatus 200 or each of MFPs 100, 100A, and 100B. The data includes Web data written in markup language.

In the following description, portable information apparatus 200 communicates with MFP 100, by way of example. When portable information apparatus 200 and MFP 100 communicate, one of portable information apparatus 200 and MFP 100 serves as a server, while the other serves as a client. The server-side apparatus is remotely operated from the client-side apparatus. In a case where portable information apparatus 200 functions as a server and MFP 100 functions as a client, an operation screen for remotely operating portable information apparatus 200 and an operation screen for operating MFP 100 are simultaneously displayed on the operation panel of MFP 100. In the following, the operation screen displayed on the operation panel of MFP 100 for remotely operating portable information apparatus 200 is called a second remote operation screen, and the operation screen for operating MFP 100 is called a first self-operation screen. In a case where MFP 100 functions as a server and portable information apparatus 200 functions as a client, an operation screen for remotely operating MFP 100 and an operation screen for operating portable information apparatus 200 are simultaneously displayed on a Liquid Crystal Display (LCD) of portable information apparatus 200. In the following, the operation screen displayed on the LCD of portable information apparatus 200 for remotely operating MFP 100 is called a first remote operation screen, and the operation screen for operating portable information apparatus 200 is called a second self-operation screen. In this case, the first remote operation screen is the same as the first self-operation screen, and the second remote operation screen is the same as the second self-operation screen. The first remote operation screen may not be the same as the first self-operation screen as long as it corresponds to the first self-operation screen. The second remote operation screen may not be the same as the second self-operation screen as long as it corresponds to the second self-operation screen.

MFPs 100, 100A, and 100B may have the same hardware configuration or may have different hardware configurations as long as they at least have an image forming unit for forming an image on a sheet of paper or the like based on image data. Although the hardware configurations of MFPs 100, 100A, and 100B may not be the same, here, it is assumed that MFP 100 has a configuration of at least one of other MFPs 100A and 100B, and MFP 100 is taken as an example in the following description, unless otherwise specified.

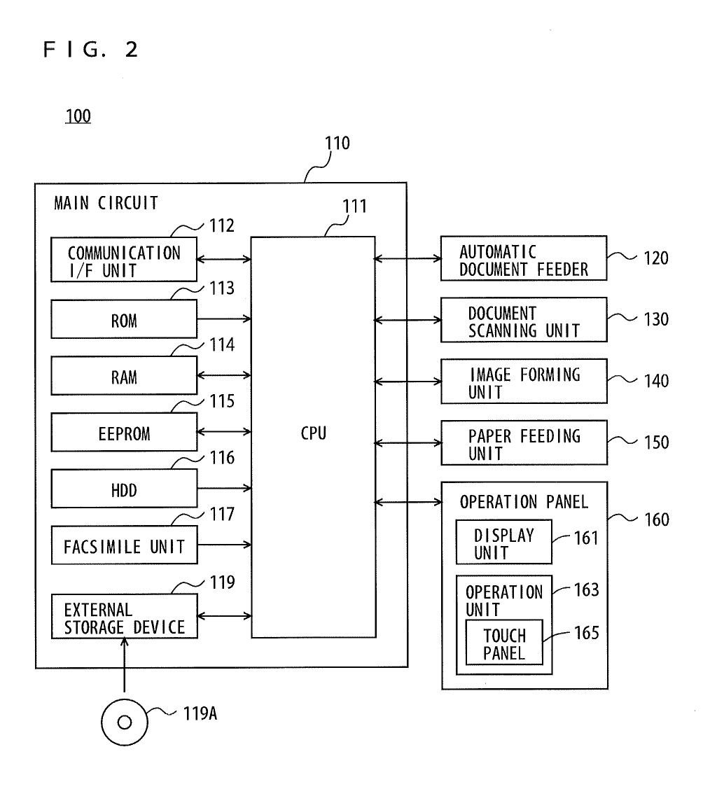

FIG. 2 is a block diagram showing an overall hardware configuration of the MFP. Referring to FIG. 2, MFP 100 includes a main circuit 110, a document scanning unit 130 for scanning a document, an automatic document feeder (ADF) 120 for conveying a document to document scanning unit 130, an image forming unit 140 for forming an image on paper or the like based on image data output by document scanning unit 130 scanning a document, a paper-feeding unit 150 for supplying paper to image forming unit 140, and an operation panel 160 serving as a user interface.

Main circuit 110 includes a CPU 111, a communication interface (I/F) unit 112, a ROM 113, a RAM 114, an EEPROM (Electronically Erasable and Programmable ROM) 115, an HDD (Hard Disk Drive) 116 serving as mass storage device, a facsimile unit 117, and an external storage device 119 to which a CD-ROM (Compact Disc-Read Only Memory) 119A is attached. CPU 111 is connected to ADF 120, document scanning unit 130, image forming unit 140, paper-feeding unit 150, and operation panel 160 to control the entire MFP 100.

ROM 113 stores a program executed by CPU 111 or data necessary to execute the program. RAM 114 is used as a working area for CPU 111 to execute a program. RAM 114 temporarily stores scan data (image data) successively sent from document scanning unit 130.

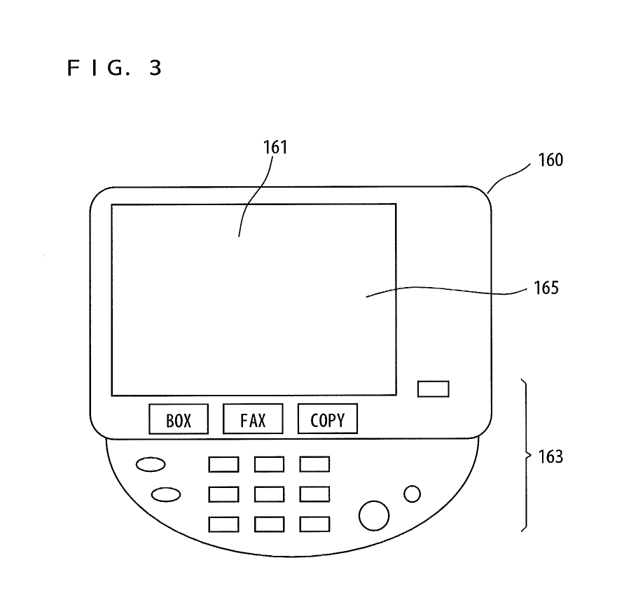

Operation panel 160 is provided on a top face of MFP 100. FIG. 3 is a plan view showing an example of the operation panel. Referring to FIG. 3, operation panel 160 includes a display unit 161 and an operation unit 163. Display unit 161 is a display such as an LCD (Liquid Crystal Display) or an organic ELD (Electroluminescence Display) for displaying instruction menus to the user, information about the acquired image data, and the like. Operation unit 163 includes a plurality of keys for accepting input of various instructions, characters, and numerals through the user's operation corresponding to the keys. Operation unit 163 further includes a touch panel 165 for detecting a position on a display surface of display unit 161. Touch panel 165 is provided on an upper surface or a lower surface of display unit 161 and outputs the coordinates of the position designated by the user to CPU 111.

Returning to FIG. 2, communication I/F unit 112 is an interface for connecting MFP 100 to network 3. CPU 111 communicates with other MFPs 100A and 100B or radio station 5 connected to network 3 through communication I/F unit 112 to transmit/receive data. Communication I/F unit 112 can communicate with a computer connected to the Internet via network 3.

Facsimile unit 117 is connected to a PSTN (Public Switched Telephone Network) to transmit/receive facsimile data. Facsimile unit 117 converts image data scanned by document scanning unit 130 or data stored in HDD 116 into facsimile data and transmits the facsimile data to a facsimile machine connected to the PSTN. Facsimile unit 117 stores the received facsimile data into HDD 116 or allows image forming unit 140 to form an image of the facsimile data on a sheet of paper.

CD-ROM 119A is attached to external storage device 119. CPU 111 can access CD-ROM 119A through external storage device 119. CPU 111 loads a program recorded in CD-ROM 119A attached to external storage device 119 into RAM 114 for execution. The program executed by CPU 111 is not limited to a program recorded in CD-ROM 119A, and a program stored in HDD 116 may be loaded to RAM 114 for execution. In this case, another computer connected to the network may overwrite the program stored in HDD 116 of MFP 100 or additionally write a new program. MFP 100 may download a program from another computer connected to the network and store the downloaded program into HDD 116. The program referred to here includes not only a program directly executable by CPU 111 but also a source program, a compressed program, an encrypted program, and the like.

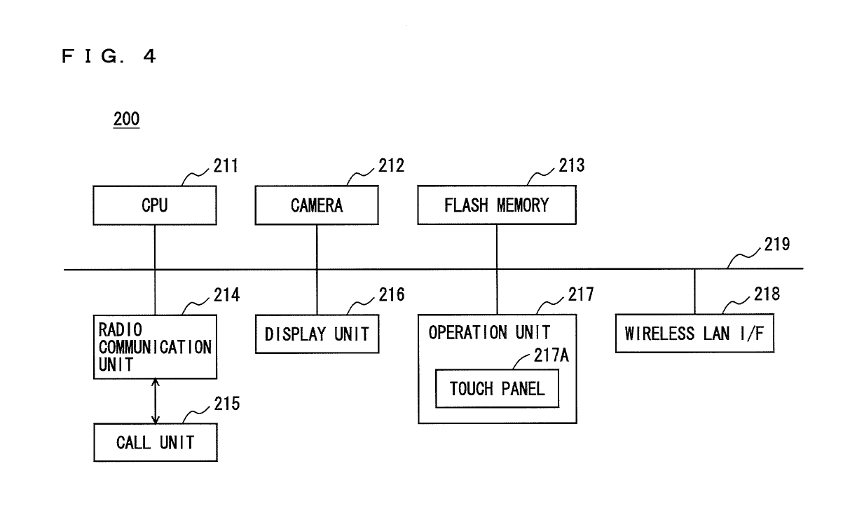

FIG. 4 is a block diagram showing an overall hardware configuration of the portable information apparatus. Referring to FIG. 4, portable information apparatus 200 includes a CPU 211 for controlling portable information apparatus 200 as a whole, a camera 212, a flash memory 213 for storing data in a nonvolatile manner, a call unit 215, a radio communication unit 214 connected to call unit 215, a display unit 216 for displaying information, an operation unit 217 for accepting user's operation input, and a wireless LAN interface (I/F) 218.

Radio communication unit 214 communicates by radio with a base station for mobile phones that is connected to a telephone communication network. Radio communication unit 214 connects portable information apparatus 200 to the telephone communication network to enable a call using call unit 215. Radio communication unit 214 decodes a voice signal obtained by demodulating a radio signal received from the base station for mobile phones, and outputs the decoded signal to call unit 215. Radio communication unit 214 encodes voice input from call unit 215 and transmits the encoded voice to the base station for mobile phones. Call unit 215 includes a microphone and a speaker to output voice input from radio communication unit 214 from the speaker and output voice input from the microphone to radio communication unit 214. Radio communication unit 214 is controlled by CPU 211 to transmit/receive data through the base station for mobile phones and, for example, connect portable information apparatus 200 to the Internet.

Camera 212 includes a lens and a photoelectric transducer element such as a CMOS (Complementary Metal Oxide Semiconductor) sensor. Light collected by the lens is focused on the CMOS sensor, which in turn transduces the received light and outputs image data to CPU 201.

Display unit 216 is a display such as an LCD or an organic ELD for displaying instruction menus to the user, the externally received data, and the like. Operation unit 217 includes a plurality of keys for accepting input of various instructions and data such as characters and numerals through the user's operation corresponding to the keys.

Operation unit 217 includes a touch panel 217A. Touch panel 217A detects a position designated by the user on a display surface of display unit 216. Touch panel 217A is provided on an upper surface or a lower surface of display unit 216 and outputs the coordinates of the position designated by the user to CPU 211. Touch panel 217A is a multi-touch screen panel. When the user designates a plurality of positions simultaneously, touch panel 217A outputs a plurality of coordinates corresponding to a plurality of positions designated by the user to CPU 211. Preferably, touch panel 217A has a size equal to or larger than the display surface of display unit 216. Touch panel 217A is provided to be overlaid on display unit 216. Therefore, when the user designates the display surface of display unit 216, touch panel 217A outputs one or more coordinates corresponding to one or more positions designated by the user on the display surface of display unit 216 to CPU 211. Touch panel 217A may employ any system, for example, such as a resistive film system, a surface acoustic wave system, an infrared system, an electromagnetic induction system, or an electrostatic capacity system.

Wireless LAN I/F 218 is an interface communicating with radio station 5 for connecting portable information terminal 200 to network 3. Portable information apparatus 200 can communicate with MFPs 100, 100A, and 100B through wireless LAN I/F 218 and transmit/receive data.

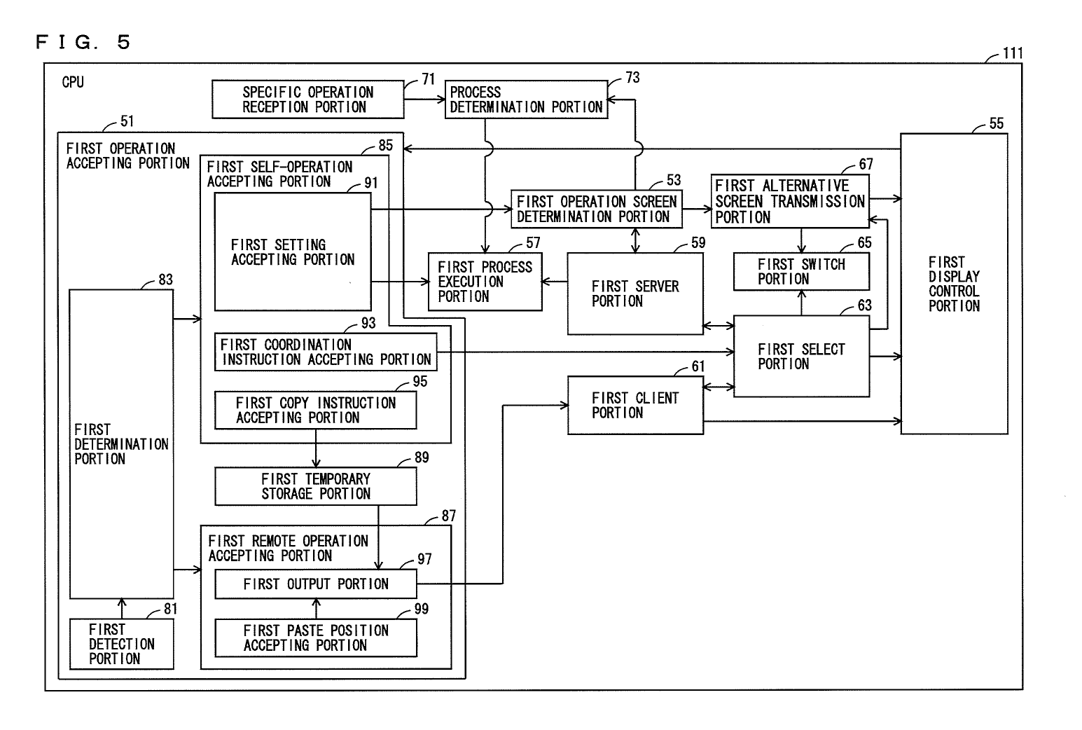

FIG. 5 is a diagram showing an example of functions of the CPU of the MFP. The functions shown in FIG. 5 are formed in CPU 111 by CPU 111 of MFP 100 executing an image processing apparatus coordination program stored in ROM 113, EEPROM 115, HDD 116, or CD-ROM 119A. Referring to FIG. 5, CPU 111 includes a first operation accepting portion 51 for accepting an operation, a first operation screen determination portion 53 for determining an operation screen, a first display control portion 55 for controlling display unit 161, a first process execution portion 57 for executing a process, a first server portion 59 functioning as a server, a first client portion 61 functioning as a client, a first select portion 63, a first switch portion 65 for switching operation modes of display unit 161, a first alternative screen transmission portion 67, a specific operation reception portion 71 receiving a specific operation, and a process determination portion 73 for determining a process corresponding to a specific operation.

First select portion 63 selects one of a first state in which first server portion 59 can communicate with portable information apparatus 200 functioning as a client and a second state in which first client portion 61 can communicate with portable information apparatus 200 functioning as a server while communication I/F unit 112 can communicate with portable information apparatus 200.

When selecting the first state, first select portion 63 outputs a first status signal to first switch portion 65, first server portion 59, and first alternative screen transmission portion 67 and outputs the apparatus identification information of portable information apparatus 200 functioning as a client to first server portion 59. When selecting the second state, first select portion 63 outputs a second status signal to first switch portion 65, first client portion 61, and first display control portion 55 and outputs the apparatus identification information of portable information apparatus 200 functioning as a server to first client portion 61.

First select portion 63 outputs a coordination setting screen to first display control portion 55 and allows display unit 161 to display the coordination setting screen. The coordination setting screen is a screen for setting one of portable information apparatus 200 and MFP 100 as a client.

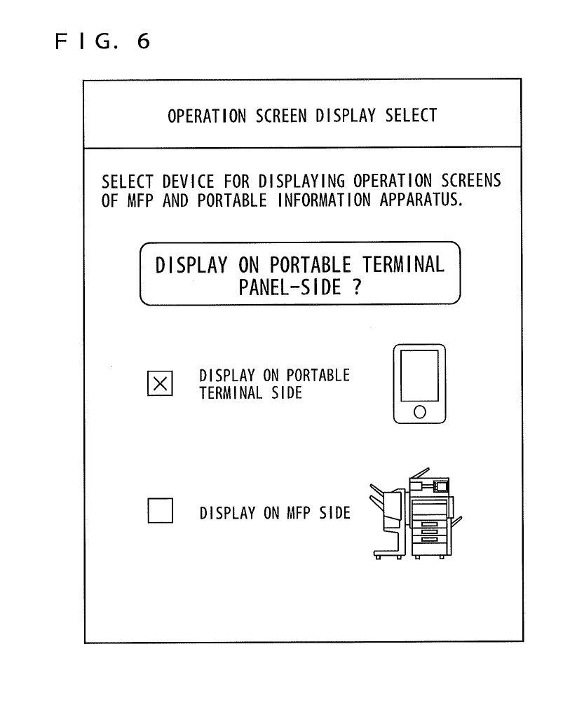

FIG. 6 is a diagram showing an example of the coordination setting screen. Referring to FIG. 6, the coordination setting screen includes a message “Select a device for displaying operation screens of MFP and portable terminal,” a check box identified with a message “Display on the portable terminal side” for selecting portable information apparatus 200 as a client, and a check box identified with a message “Display on the MFP side” for selecting MFP 100 as a client. When the user designates the check box for selecting portable information apparatus 200 as a client, portable information apparatus 200 is selected as a client. When the user designates the check box for selecting MFP 100 as a client, MFP 100 is selected as a client. In FIG. 6, the check box for selecting portable information apparatus 200 as a client is designated, and portable information apparatus 200 is selected as a client, by way of example.

Returning to FIG. 5, the user who views the coordination setting screen shown in FIG. 6 can select one of portable information apparatus 200 and MFP 100 as a client. The select operation by the user is accepted by first coordination instruction accepting portion 93 described later, and a coordination instruction is output from first coordination instruction accepting portion 93 to first select portion 63. The coordination instruction includes an instruction indicating functioning as a server and an instruction indicating functioning as a client. When indicating functioning as a client, the coordination instruction includes the apparatus identification information for identifying portable information apparatus 200 functioning as a server. When indicating functioning as a server, the coordination instruction includes the apparatus identification information of portable information apparatus 200 functioning as a client.

When the coordination instruction indicating functioning as a server is input, first select portion 63 selects the first state and outputs the first status signal and the apparatus identification information of portable information apparatus 200 functioning as a client to first server portion 59. In response to input of the first status signal, first server portion 59 is activated and communicates with portable information apparatus 200 through communication I/F unit 112. First server portion 59 may be resident in CPU 111. In this case, first server portion 59 communicates with portable information apparatus 200 through communication I/F unit 112 in response to input of the first status signal.

When the coordination instruction indicating functioning as a client is input, first select portion 63 selects the second state and outputs the second status signal and the apparatus identification information of portable information apparatus 200 functioning as a server to first client portion 61. In response to input of the second status signal, first client portion 61 is activated and communicates with portable information apparatus 200 through communication I/F unit 112.

First server portion 59 may start communication in response to a request from portable information apparatus 200 functioning as a client. First select portion 63 selects the first state when it is detected that first server portion 59 starts communication with portable information apparatus 200 functioning as a client. First client portion 61 may be activated in response to a request from portable information apparatus 200 functioning as a server, and first client portion 61 may start communication with portable information apparatus 200. First select portion 63 selects the second state when it is detected that first client portion 61 starts communication with portable information apparatus 200 functioning as a server.

First operation screen determination portion 53 determines a first self-operation screen for operating MFP 100 to be displayed on display unit 161. First operation screen determination portion 53 determines the first self-operation screen in accordance with an operation by the user that is accepted by first operation accepting portion 51 described later or in accordance with an operation received from the client by first server portion 59 as described later. First operation screen determination portion 53 outputs the determined first self-operation screen to first alternative screen transmission portion 67.

First alternative screen transmission portion 67 receives the first self-operation screen from first operation screen determination portion 53. When the first status signal is not input from first select portion 63 and MFP 100 does not function as a server, first alternative screen transmission portion 67 outputs the first self-operation screen input from first operation screen determination portion 53 to first display control portion 55. When the first status signal is input from first select portion 63, and, while MFP 100 functions as a server, the first self-operation screen input from first operation screen determination portion 53 is a predetermined first specific operation screen, first alternative screen transmission portion 67 outputs a predetermined first alternative screen corresponding to the first specific operation screen to first server portion 59 in place of the first specific operation screen and outputs the first specific operation screen to first display control portion 55. First server portion 59 transmits the first alternative screen to portable information apparatus 200 functioning as a client through communication I/F unit 112. Therefore, portable information apparatus 200 displays the first alternative screen without displaying the first specific operation screen.

While MFP 100 functions as a server, first alternative screen transmission portion 67 also outputs a drive instruction to first switch portion 65 in response to input of the first specific operation screen from first operation screen determination portion 53.

First server portion 59 communicates with portable information apparatus 200 functioning as a client through communication I/F unit 112 and functions as a server remotely operated by portable information apparatus 200. Specifically, first server portion 59 transmits the first self-operation screen or the first alternative screen input from first alternative screen transmission portion 67 as the first remote operation screen to portable information apparatus 200. When receiving positional information indicating a position in the first self-operation screen (first remote operation screen) from portable information apparatus 200, first server portion 59 accepts an instruction by the user who operates portable information apparatus 200, based on the received positional information.

The operation accepted by first server portion 59 is the same as the operation accepted by operation unit 163 when the user operates MFP 100 using operation unit 163. More specifically, the operation accepted by first server portion 59 is determined by the first self-operation screen. In a case where the first self-operation screen is a screen for setting a setting value, an operation for setting a setting value is accepted. In a case where the first self-operation screen has a button to which an instruction to execute a process is allocated, an operation for giving an instruction to execute a process is accepted when the position of the button is received. When the accepted operation is an operation for giving an instruction to execute a process, first server portion 59 outputs a command for executing a process to first process execution portion 57.

First client portion 61 communicates with portable information apparatus 200 functioning as a server through communication I/F unit 112 and functions as a client remotely operating portable information apparatus 200. Specifically, first client portion 61 receives the second remote operation screen for the user to remotely operate portable information apparatus 200 from potable information apparatus 200 and outputs the received second remote operation screen to first display control portion 55. First display control portion 55 controls display unit 161 and allows display unit 161 to display an image. First display control portion 55 allows display unit 161 to display the second remote operation screen input from first client portion 61. Therefore, the user who operates MFP 100 can remotely operate portable information apparatus 200 while viewing the second remote operation screen displayed on display unit 161.

First client portion 61 receives positional information indicating a position in the second remote operation screen from first remote operation accepting portion 87 described later. When the user touches the second remote operation screen with the finger, first remote operation accepting portion 87, which will be detailed later, outputs positional information indicating the position in the second remote operation screen to first client portion 61 based on the positional information input from touch panel 165. First client portion 61 transmits the positional information input from first remote operation accepting portion 87 to portable information apparatus 200 through communication I/F unit 112.

First display control portion 55 allows display unit 161 to display the first self-operation screen input from first alternative screen transmission portion 67. When the second status signal is input from first select portion 63, first display control portion 55 receives the second remote operation screen from first client portion 61 and allows display unit 161 to display a screen in which the first self-operation screen and the second remote operation screen are arranged side by side. Therefore, when the second status signal is input from first select portion 63, in other words, when MFP 100 functions as a client, the first self-operation screen and the second remote operation screen are displayed simultaneously on display unit 161, so that the user can operate MFP 100 and can also remotely operate portable information apparatus 200 while viewing display unit 161.

First display control portion 55 outputs display information to first operation accepting portion 51. In a case where only the first self-operation screen is displayed on display unit 161, the display information includes operation screen identification information for identifying the first self-operation screen and positional information indicating the position of the first self-operation screen in the display surface of display unit 161. In a case where the first self-operation screen and the second remote operation screen are displayed on display unit 161, the display information includes positional information indicating the position of the second remote operation screen in the display surface of display unit 161, in addition to operation screen identification information for identifying the first self-operation screen and positional information indicating the position of the first self-operation screen in the display surface of display unit 161.

First switch portion 65 switches operation modes of display unit 161 based on the first status signal input from first select portion 63. The operation modes of display unit 161 include a normal mode and a power saving mode in which power consumption is smaller than in the normal mode. The power saving mode includes a state in which display unit 161 displays no image and includes a case where power is not supplied to display unit 161. In response to input of the first status signal from first select portion 63, first switch portion 65 switches the operation mode of display unit 161 from the normal mode to the power saving mode. Therefore, when the first select portion 63 outputs the first status signal, in other words, when MFP 100 functions as a server, the operation mode of display unit 161 is switched to the power saving mode, thereby reducing power consumption while MFP 100 functions as a server.

When a drive instruction is input from first alternative screen transmission portion 67 with the operation mode switched to the power saving mode, first switch portion 65 switches the operation mode of display unit 161 from the power saving mode to the normal mode.

First operation accepting portion 51 receives display information from first display control portion 55 and accepts an operation input by the user. The operation input by the user includes a self-operation that is an operation on the MFP itself and a remote operation that is an operation on the portable information apparatus. First operation accepting portion 51 includes a first detection portion 81 for detecting a position designated by the user on the display surface of display unit 161, a first determination portion 83 for determining the self-operation or the remote operation based on the detected position, a first remote operation accepting portion 87 for accepting the remote operation based on the determination result, a self-operation accepting portion 85 for accepting the self-operation based on the determination result, and a first temporary storage portion 89.

First detection portion 81 is connected to touch panel 165 and receives from touch panel 165 a coordinate value of the position designated by the user on the display surface of display unit 161. First detection portion 81 outputs the coordinate value input from touch panel 165 to first determination portion 83.

First determination portion 83 determines whether the position indicated by the coordinate value input from first detection portion 81 belongs to the first self-operation screen or the second remote operation screen, based on the display information input from first display control portion 55. When the position indicated by the coordinate value input from first detection portion 81 belongs to the first self-operation screen, first determination portion 83 determines as the self-operation. When the position indicated by the coordinate value input from first detection portion 81 belongs to the second remote operation screen, first determination portion 83 determines as a remote operation.

When it is determined as the self-operation, first determination portion 83 converts the coordinate value input from first detection portion 81 into a coordinate value indicating the position in the self-operation screen and outputs positional information including the converted coordinate value to first self-operation accepting portion 85. When it is determined as the remote operation, first determination portion 83 converts the coordinate value input from first detection portion 81 into a coordinate value indicating the position in the second remote operation screen and outputs positional information including the converted coordinate value to first remote operation accepting portion 87.

First self-operation accepting portion 85 includes a first setting accepting portion 91, a first coordination instruction accepting portion 93, and a first copy instruction accepting portion 95. First setting accepting portion 91 accepts an operation by the user, based on the first self-operation screen specified by the display information input from first display control portion 55 and the positional information input from first determination portion 83. The operation by the user is determined by the first self-operation screen specified by the display information input from first display control portion 55. In a case where the first self-operation screen is a screen for setting a setting value, an operation for setting a setting value is accepted. In a case where the first self-operation screen has a button to which an instruction to execute a process is allocated, an operation of giving an instruction to execute a process is accepted when the positional information indicating the position of the button is input. When the accepted operation is an operation of giving an instruction to execute a process, first setting accepting portion 91 outputs a process execution instruction to first process execution portion 57.

First coordination instruction accepting portion 93 accepts the user's operation of selecting one of portable information apparatus 200 and MFP 100 as a client in a state in which the coordination setting screen shown in FIG. 6 appears on display unit 161. In the state in which the coordination setting screen appears on display unit 161, it is determined which of the check box for selecting portable information apparatus 200 as a client and the check box for selecting MFP 100 as a client is designated, based on the positional information input from first determination portion 83. When the positional information indicates the check box for selecting portable information apparatus 200 as a client, the operation of selecting portable information apparatus 200 as a client is accepted. When the positional information indicates the check box for selecting MFP 100 as a client, the operation of selecting MFP 100 as a client is accepted. When the operation of selecting portable information apparatus 200 as a client is accepted, first coordination instruction accepting portion 93 outputs a coordination instruction including a coordination instruction indicating functioning as a server and the apparatus identification information of portable information apparatus 200 functioning as a client to first select portion 63. When the operation of selecting MFP 100 as a client is accepted, first coordination instruction accepting portion 93 outputs a coordination instruction including a coordination instruction indicating functioning as a client and the apparatus identification information of portable information apparatus 200 functioning as a server to first select portion 63.

First copy instruction accepting portion 95 accepts an operation of designating a character string included in the first self-operation screen and outputs the designated character string to first temporary storage portion 89. First temporary storage portion 89 temporarily stores the character string input from first copy instruction accepting portion 95 into a buffer. When the user inputs a copy instruction to copy a character string, first copy instruction accepting portion 95 accepts the copy instruction and specifies the character string included in the first self-operation screen based on the positional information input from first determination portion 83. First copy instruction accepting portion 95 accepts a copy instruction when the same positional information is continuously input from first determination portion 83 for a prescribed time T1 or longer. A copy instruction may be accepted when a time period during which the same positional information is input from first determination portion 83 is equal to or shorter than a prescribed time. A copy instruction may be accepted when a predetermined key provided in operation unit 163 is designated.

First remote operation accepting portion 87 outputs the positional information input from first determination portion 83 to first client portion 61. First remote operation accepting portion 87 includes a first output portion 97 and a first paste position accepting portion 99.

First paste position accepting portion 99 accepts the position specified by the positional information input from first determination portion 83 as a paste position if a character string is stored in the buffer by first temporary storage portion 89. First paste position accepting portion 99 outputs positional information including the coordinate value of the paste position to first output portion 97.

In response to input of the positional information including the coordinate value of the paste position from first paste position accepting portion 99, first output portion 97 reads out the character string stored by first temporary storage portion 89 from the buffer and outputs a set of the positional information including the coordinate value of the paste position and the character string to first client portion 61. When the set of the positional information and the character string is input, first client portion 61 assumes that the character string is input to the paste position specified by the positional information in the second remote operation screen. Specifically, the character string and the positional information are transmitted to portable information apparatus 200 functioning as a server. Accordingly, the character string included in the first self-operation screen displayed on display unit 161 can be input to the paste position in the second remote operation screen displayed on display unit 161.

Specific operation reception portion 71 controls communication I/F unit 112 to receive specific operation information from portable information apparatus 200 functioning as a client and output the received specific operation information to process determination portion 73. The specific operation information, which will be detailed later, includes positional information indicating the position in the first self-operation screen determined by first operation screen determination portion 53, and the amount of change.

Process determination portion 73 receives the first self-operation screen from first operation screen determination portion 53 and receives the specific operation information from specific operation reception portion 71. Process determination portion 73 determines a process based on the first self-operation screen and the specific operation information. Specifically, process determination portion 73 specifies, among operations that can be input on the first self-operation screen, an operation allocated to the position in the first self-operation screen as specified by the positional information included in the specific operation information, or an operation corresponding to an image at a position in the first self-operation screen as specified by the positional information included in the specific operation information, with designation of the amount of change. For example, the position in the first operation screen as specified by the positional information included in the specific operation information is in an image, an operation of enlarging or reducing the image is specified. If the amount of change is positive, an operation of enlarging is specified. If the amount of change is negative, an operation of reducing is specified. When the position in the first operation screen as specified by the positional information included in the specific operation information is in a region in which a parameter is input, an operation of increasing or reducing the parameter is specified.

Process determination portion 73 outputs a command for executing a process corresponding to the specified operation, a parameter determined by the amount of change included in the specific operation information, and data identification information for specifying data to be processed, to first process execution portion 57. Here, a case where an operation of enlarging an image included in the first self-operation screen is specified will be described by way of example. In this case, the data identification information of the image included in the first self-operation screen, an enlarge command for executing a process of enlarging the image, and a magnification are output to first process execution portion 57.

First process execution portion 57 executes a process based on the command and the parameter, where the data specified by the data identification information input from process determination portion 73 is set as a process target. Accordingly, the image included in the first self-operation screen is enlarged. First operation screen determination portion 53 determines the first self-operation screen with the enlarged image, as the next screen to be displayed. First server portion 59 transmits the first self-operation screen with the enlarged image to portable information apparatus 200 functioning as a client. Accordingly, the first self-operation screen with the enlarged image appears as the first remote operation screen at portable information apparatus 200 functioning as a client.

As described above, while MFP 100 functions as a server, in response to input of a predetermined first specific operation screen from first operation screen determination portion 53, first alternative screen transmission portion 67 outputs a predetermined first alternative screen corresponding to the first specific operation screen, in place of the first specific operation screen, to first server portion 59, outputs the first specific operation screen to first display control portion 55, and outputs a drive instruction to first switch portion 65. The first specific operation screen is, for example, a screen that prompts for an operation on MFP 100 functioning as a server. For example, the screen prompts for an operation of inserting a memory stick to a memory connection socket provided at the operation panel of MFP 100. In the following, the predetermined first self-operation screen is called a direct operation instruction screen.

Thus, first server portion 59 transmits the first alternative screen to portable information apparatus 200 functioning as a client, so that portable information apparatus 200 displays the first alternative screen without displaying the first specific operation screen. When a drive instruction is input from first alternative screen transmission portion 67 to first switch portion 65, the first specific operation screen is output to first display control portion 55. In order to allow display unit 161 to display the first specific operation screen, first switch portion 65 switches the operation mode of display unit 161 to the normal mode.

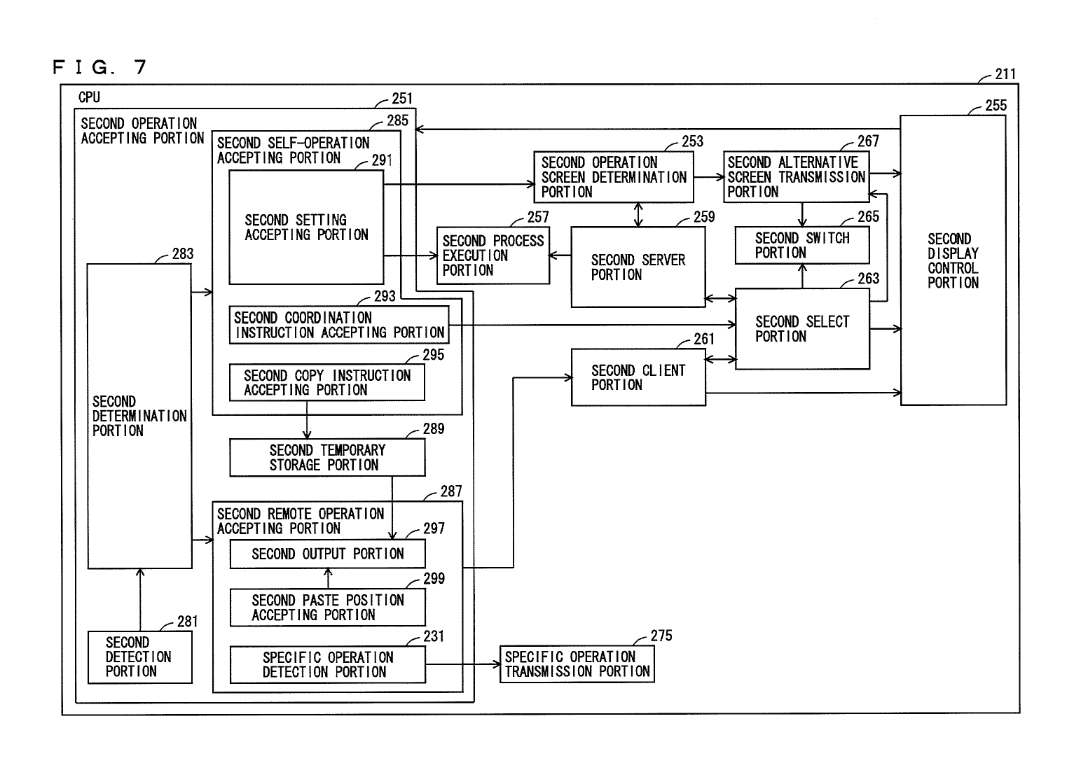

FIG. 7 is a diagram showing an example of functions of the CPU of the portable information apparatus. The functions shown in FIG. 7 are formed in CPU 211 by CPU 211 of portable information apparatus 200 executing a portable information apparatus coordination program stored in flash memory 213. Referring to FIG. 7, CPU 211 includes a second operation accepting portion 251 for accepting an operation, a second operation screen determination portion 253 for determining an operation screen, a second display control portion 255 for controlling display unit 216, a second process execution portion 257 for executing a process, a second server portion 259 functioning as a server, a second client portion 261 functioning as a client, a second select portion 263, a second switch portion 265 for switching operation modes of display unit 216, a second alternative screen transmission portion 267, and a specific operation transmission portion 275 for transmitting a specific operation.

Second select portion 263 selects one of a first state in which second server portion 259 can communicate with MFP 100 functioning as a client and a second state in which second client portion 261 can communicate with MFP 100 functioning as a server while wireless LAN I/F 218 can communicate with MFP 100.

When selecting the first state, second select portion 263 outputs a first status signal to second switch portion 265, second server portion 259, and second alternative screen transmission portion 267 and outputs the apparatus identification information of MFP 100 functioning as a client to second server portion 259. When selecting the second state, second select portion 263 outputs a second status signal to second switch portion 265, second client portion 261, and second display control portion 255 and outputs the apparatus identification information of MFP 100 functioning as a server to second client portion 261.

Second select portion 263 outputs a coordination setting screen to second display control portion 255 and allows display unit 216 to display the coordination setting screen. The coordination setting screen is similar to that shown in FIG. 6. The user's select operation of selecting one of portable information apparatus 200 and MFP 100 as a client is accepted by second coordination instruction accepting portion 293 as described later, and a coordination instruction is output from second coordination instruction accepting portion 293 to second select portion 263.

When the coordination instruction indicating functioning as a server is input, second select portion 263 selects the first state and outputs the first status signal and the apparatus identification information of MFP 100 functioning as a client to second server portion 259. In response to input of the first status signal, second server portion 259 is activated and communicates with MFP 100 through wireless LAN I/F 218. Second server portion 259 may be resident in CPU 211. In this case, second server portion 259 communicates with MFP 100 through wireless LAN I/F 218 in response to input of the first status signal.

When the coordination instruction indicating functioning as a client is input, second select portion 263 selects the second state and outputs the second status signal and the apparatus identification information of MFP 100 functioning as a server to second client portion 261. In response to input of the second status signal, second client portion 261 is activated and communicates with MFP 100 through wireless LAN I/F 218.

Second server portion 259 may start communication in response to a request from MFP 100 functioning as a client. Second select portion 263 selects the first state when it is detected that second server portion 259 starts communication with MFP 100 functioning as a client. Second client portion 261 may be activated in response to a request from MFP 100 functioning as a server, and second client portion 261 may start communication with MFP 100. Second select portion 263 selects the second state when it is detected that second client portion 261 starts communication with MFP 100 functioning as a server.

Second operation screen determination portion 253 determines a second self-operation screen for operating portable information apparatus 200 to be displayed on display unit 216. Second operation screen determination portion 253 determines the second self-operation screen in accordance with an operation by the user that is accepted by second operation accepting portion 251 described later or in accordance with an operation received from the client by second server portion 259 as described later. Second operation screen determination portion 253 outputs the determined second self-operation screen to second alternative screen transmission portion 267.

Second alternative screen transmission portion 267 receives the second self-operation screen from second operation screen determination portion 253. When the first status signal is not input from second select portion 263 and portable information apparatus 200 does not function as a server, second alternative screen transmission portion 267 outputs the second self-operation screen input from second operation screen determination portion 253 to second display control portion 255. When the first status signal is input from second select portion 263, and, while portable information apparatus 200 functions as a server, the second self-operation screen input from second operation screen determination portion 253 is a predetermined second specific operation screen, second alternative screen transmission portion 267 outputs a predetermined second alternative screen corresponding to the second specific operation screen to second server portion 259 in place of the second specific operation screen and outputs the second specific operation screen to second display control portion 255. Second server portion 259 transmits the second alternative screen to MFP 100 functioning as a client through wireless LAN I/F 218. Therefore, portable information apparatus 200 displays the second alternative screen without displaying the second specific operation screen.

While portable information apparatus 200 functions as a server, second alternative screen transmission portion 267 also outputs a drive signal to second switch portion 265 in response to input of the second specific operation screen from second operation screen determination portion 253.

Second server portion 259 communicates with MFP 100 functioning as a client through wireless LAN I/F unit 218 and functions as a server remotely operated by MFP 100. Specifically, second server portion 259 transmits the second self-operation screen or the second alternative screen input from second alternative screen transmission portion 267 as the second remote operation screen to MFP 100. When receiving positional information indicating a position in the second self-operation screen (second remote operation screen) from MFP 100, second server portion 259 accepts an instruction by the user who operates MFP 100 based on the received positional information. The operation accepted by second server portion 259 is the same as the operation accepted by operation unit 217 when the user operates portable information apparatus 200 using operation unit 217.

Second client portion 261 communicates with MFP 100 functioning as a server through wireless LAN I/F 218 and functions as a client remotely operating MFP 100. Specifically, second client portion 261 receives the first remote operation screen for the user to remotely operate MFP 100 from MFP 100 and outputs the received first remote operation screen to second display control portion 255. Second display control portion 255 controls display unit 216 and allows display unit 216 to display an image. Second display control portion 255 allows display unit 216 to display the first remote operation screen input from second client portion 261. Therefore, the user who operates portable information apparatus 200 can remotely operate MFP 100 while viewing the first remote operation screen displayed on display unit 216.

Second client portion 261 receives positional information indicating a position in the first remote operation screen from second remote operation accepting portion 287 described later. When the user touches the first remote operation screen with the finger, second remote operation accepting portion 287, which will be detailed later, outputs positional information indicating the position in the first remote operation screen to second client portion 261 based on the positional information input from touch panel 217A. Second client portion 261 transmits the positional information input from second remote operation accepting portion 287 to MFP 100 through wireless LAN I/F 218.

Second display control portion 255 allows display unit 216 to display the second self-operation screen input from second alternative screen transmission portion 267. When the second status signal is input from second select portion 263, second display control portion 255 receives the first remote operation screen from second client portion 261 and allows display unit 216 to display a screen in which the second self-operation screen and the first remote operation screen are arranged side by side. Therefore, when the second status signal is input from second select portion 263, in other words, when portable information apparatus 200 functions as a client, the second self-operation screen and the first remote operation screen are displayed simultaneously on display unit 216, so that the user can operate potable information apparatus 200 and can also remotely operate MFP 100 while viewing display unit 216.

Second display control portion 255 outputs display information to second operation accepting portion 251. In the case where only the second self-operation screen is displayed on display unit 216, the display information includes operation screen identification information for identifying the second self-operation screen and positional information indicating the position of the second self-operation screen in the display surface of display unit 216. In the case where the second self-operation screen and the first remote operation screen are displayed on display unit 216, the display information includes positional information indicating the position of the first remote operation screen in the display surface of display unit 216, in addition to operation screen identification information for identifying the second self-operation screen and positional information indicating the position of the second self-operation screen in the display surface of display unit 216.

Second switch portion 265 switches operation modes of display unit 216 based on the first status signal input from second select portion 263. The operation modes of display unit 216 include a normal mode and a power saving mode in which power consumption is smaller than in the normal mode. The power saving mode includes a state in which display unit 216 displays no image and includes a case where power is not supplied to display unit 216. In response to input of the first status signal from second select portion 263, second switch portion 265 switches the operation mode of display unit 216 from the normal mode to the power saving mode. Therefore, when portable information apparatus 200 functions as a server, the operation mode of display unit 216 is switched to the power saving mode, thereby reducing power consumption while portable information apparatus 200 functions as a server.

When a drive instruction is input from second alternative screen transmission portion 267 with the operation mode switched to the power saving mode, second switch portion 265 switches the operation mode of display unit 216 from the power saving mode to the normal mode.

Second operation accepting portion 251 receives display information from second display control portion 255 and accepts an operation input by the user. Second operation accepting portion 251 includes a second detection portion 281 for detecting a position designated by the user on the display surface of display unit 216, a second determination portion 283 for determining a self-operation or a remote operation based on the detected position, a second remote operation accepting portion 287 for accepting the remote operation based on the determination result, a second self-operation accepting portion 285 for accepting the self-operation based on the determination result, and a second temporary storage portion 289.

Second detection portion 281 is connected to touch panel 217A and receives from touch panel 217A coordinate values of one or more positions designated by the user on the display surface of display unit 216. Second detection portion 281 outputs one or more coordinate values input from touch panel 217A to second determination portion 283.

Second determination portion 283 determines whether the position indicated by the coordinate value input from second detection portion 281 belongs to the second self-operation screen or the first remote operation screen, based on the display information input from second display control portion 255. When two or more coordinate values are input from second detection portion 281, second determination portion 283 detects whether the positions indicated by two or more coordinates values both belong to the second self-operation screen or the first remote operation screen. When the positions indicated by one or more coordinate values input from second detection portion 281 belong to the second self-operation screen, second determination portion 283 determines as the self-operation. When the positions indicated by one or more coordinate values input from second detection portion 281 belong to the first remote operation screen, second determination portion 283 determines as a remote operation.

When it is determined as the self-operation, second determination portion 283 converts one or more coordinate values input from second detection portion 281 into one or more coordinate values indicating the positions in the second self-operation screen and outputs positional information including the converted one or more coordinate values to second self-operation accepting portion 285. When it is determined as the remote operation, second determination portion 283 converts one or more coordinate values input from second detection portion 281 into one or more coordinate values indicating the positions in the first remote operation screen and outputs positional information including the converted one or more coordinate values to second remote operation accepting portion 287.

Second self-operation accepting portion 285 includes a second setting accepting portion 291, a second coordination instruction accepting portion 293, and a second copy instruction accepting portion 295. Second setting accepting portion 291 accepts an operation by the user based on the second self-operation screen specified by the display information input from second display control portion 255 and the positional information input from second determination portion 283. The operation by the user is determined by the second self-operation screen specified by the display information input from second display control portion 255.

Second coordination instruction accepting portion 293 accepts the user's operation of selecting one of portable information 200 and MFP 100 as a client in a state in which a coordination setting screen similar to that shown in FIG. 6 appears on display unit 216. When the operation of selecting MFP 100 as a client is accepted, second coordination instruction accepting portion 293 outputs a coordination instruction including a coordination instruction indicating functioning as a server and the apparatus identification information of MFP 100 functioning as a client to second select portion 263. When the operation of selecting portable information apparatus 200 as a client is accepted, second coordination instruction accepting portion 293 outputs a coordination instruction including a coordination instruction indicating functioning as a client and the apparatus identification information of MFP 100 functioning as a server to second select portion 263.

Second copy instruction accepting portion 295 accepts an operation of designating a character string included in the second self-operation screen and outputs the designated character string to second temporary storage portion 289. Second temporary storage portion 289 temporarily stores the character string input from second copy instruction accepting portion 295 into a buffer. Second copy instruction accepting portion 295 accepts a copy instruction when the same positional information is continuously input from second determination portion 283 for a prescribed time T2 or longer. A copy instruction may be accepted when a time period during which the same positional information is input from second determination portion 283 is equal to or shorter than a prescribed time. A copy instruction may be accepted when a predetermined key provided in operation unit 217 is designated.

Second remote operation accepting portion 287 outputs the positional information input from second determination portion 283 to second client portion 261. Second remote operation accepting portion 287 includes a second output portion 297, a second paste position accepting portion 299, and a specific operation detection portion 231.

Second paste position accepting portion 299 accepts the position specified by the positional information input from second determination portion 283 as a paste position if a character string is stored in the buffer by second temporary storage portion 289. Second paste position accepting portion 299 outputs positional information including the coordinate value of the paste position to second output portion 297.

In response to input of the positional information including the coordinate value of the paste position from second paste position accepting portion 299, second output portion 297 reads out the character string stored by second temporary storage portion 289 from the buffer and outputs a set of the positional information including the coordinate value of the paste position and the character string to second client portion 261. When the set of the positional information and the character string is input, second client portion 261 assumes that the character string is input to the paste position specified by the positional information in the first remote operation screen. Specifically, the character string and the positional information are transmitted to MFP 100 functioning as a server. Accordingly, the character string included in the second self-operation screen displayed on display unit 216 can be input to the paste position in the first remote operation screen displayed on display unit 216.

Specific operation detection portion 231 detects a specific operation when the positional information input from second determination portion 283 indicates two or more positions in the first remote operation screen. Two or more coordinate values included in the positional information input from second determination portion 283 indicate two or more positions designated by the user on touch panel 217A. Specific operation detection portion 231 receives a plurality of coordinate values corresponding to a plurality of positions simultaneously designated from touch panel 217A.

Specific operation detection portion 231 detects a specific operation by the user based on a temporal change of two or more coordinate values included in the positional information input from second determination portion 283, and also detects the amount of change. The specific operation includes an enlargement operation and a reduction operation. The enlargement operation is an operation of designating the display surface of display unit 216 simultaneously with two fingers and widening the distance between two positions designated with the two fingers. This operation is called a pinch-out operation. Conversely, the reduction operation is an operation of designating the display surface of display unit 216 simultaneously with two fingers and narrowing the distance between two positions designated with the two fingers. This operation is called a pinch-in operation.

Specific operation detection portion 231 detects the enlargement operation or the reduction operation based on a change in distance between two coordinates specified by two or more coordinate values included in the positional information input from second determination portion 283, and also detects the amount of change. A change amount D is obtained from a first distance L1 between two coordinates at a first time and a distance L2 between two coordinates at a second time later than the first time. The change amount D is a value obtained by subtracting distance L1 from distance L2. If the change amount D is positive, it is the enlargement operation, and if a negative value, it is the reduction operation. For example, the first time may be the initial time when two coordinate values are simultaneously input from touch panel 217A, and the second time may be the time when the distance between coordinates of two coordinate values simultaneously input from touch panel 217A stops being changed.

The enlargement operation and the reduction operation are not limited to the pinch-out operation and the pinch-in operation and may be an operation of designating with three or more fingers. For example, the enlargement operation may be an operation of designating simultaneously with three or more fingers and widening the distance between two positions designated with two fingers at opposite ends of the three or more fingers, and the reduction operation may be an operation of narrowing.

When the specific operation is detected, specific operation detection portion 231 selects any one of two or more coordinate values included in the positional information input from second determination portion 283 and converts the selected coordinate value into a coordinate value indicating the position in the first remote operation screen. Specific operation detection portion 231 outputs a set of the converted coordinate value and the detected change amount D to specific operation transmission portion 275. When detecting the specific operation, specific operation detection portion 231 selects any one of two or more coordinate values included in the positional information initially input from second determination portion 283.

Specific operation transmission portion 275 transmits specific operation information including the set of the coordinate value and the change amount input from specific operation detection portion 231 to MFP 100 through wireless LAN I/F 218.

As described above, while portable information apparatus 200 functions as a server, in response to input of a predetermined second specific operation screen from second operation screen determination portion 253, second alternative screen transmission portion 267 outputs the predetermined second alternative screen corresponding to the second specific operation screen, in place of the second specific operation screen, to second server portion 259, outputs the second specific operation screen to second display control portion 255, and outputs a drive instruction to second switch portion 265. The second specific operation screen is, for example, a screen that prompts for an operation on portable information apparatus 200 functioning as a server. For example, the screen prompts for an operation of inserting a connector of a charger to a socket for charging portable information apparatus 200.

Thus, second server portion 259 transmits the second alternative screen to MFP 100 functioning as a client, so that MFP 100 displays the second alternative screen without displaying the second specific operation screen. When a drive instruction is input from second alternative screen transmission portion 267 to second switch portion 265, the second specific operation screen is output to second display control portion 255. In order to allow display unit 216 to display the second specific operation screen, second switch portion 265 switches the operation mode of display unit 216 to the normal mode.

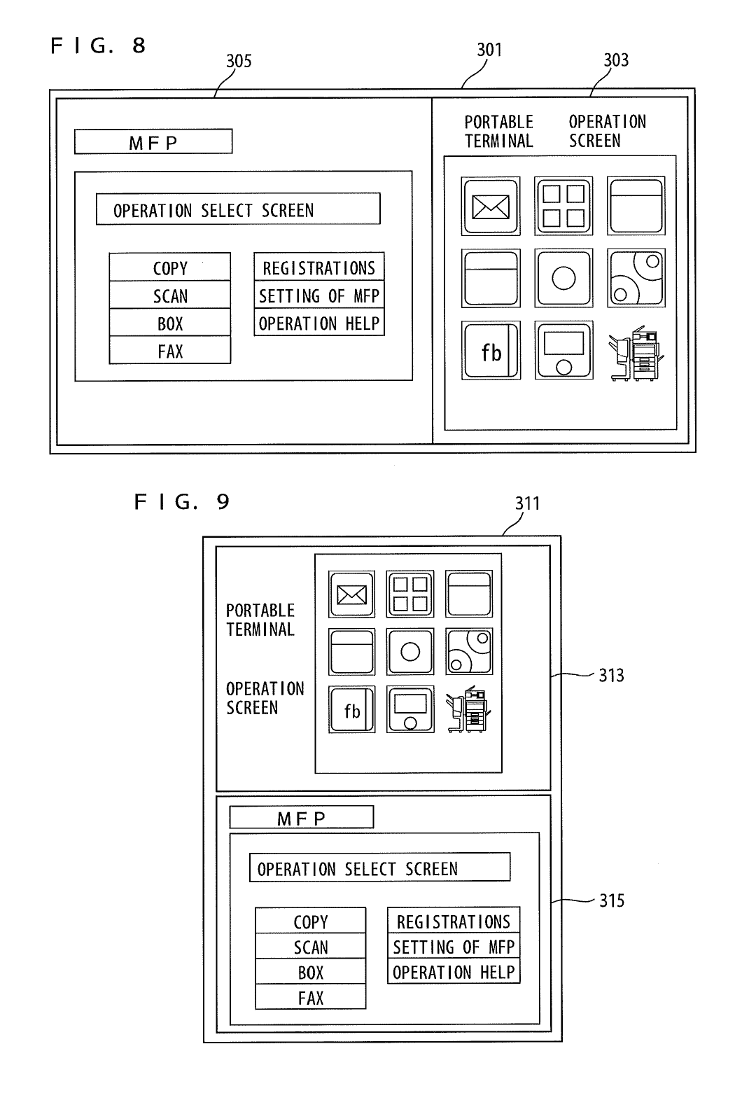

FIG. 8 is a diagram showing an example of a screen appearing on the MFP functioning as a client. Referring to FIG. 8, on a display surface 301 of display unit 161 of MFP 100, a first self-operation screen 305 for operating MFP 100 is arranged in the left region, and a second remote operation screen 303 for remotely operating portable information apparatus 200 is arranged in the right region. First self-operation screen 305 and second remote operation screen 303 are arranged side by side.

FIG. 9 is a diagram showing an example of a screen appearing on the portable information apparatus functioning as a client. Referring to FIG. 9, on a display surface 311 of display unit 216 of portable information apparatus 200, a second self-operation screen 313 is arranged in the upper region, and a first remote operation screen 315 is arranged in the lower region. Second self-operation screen 313 and first remote operation screen 315 are arranged side by side.

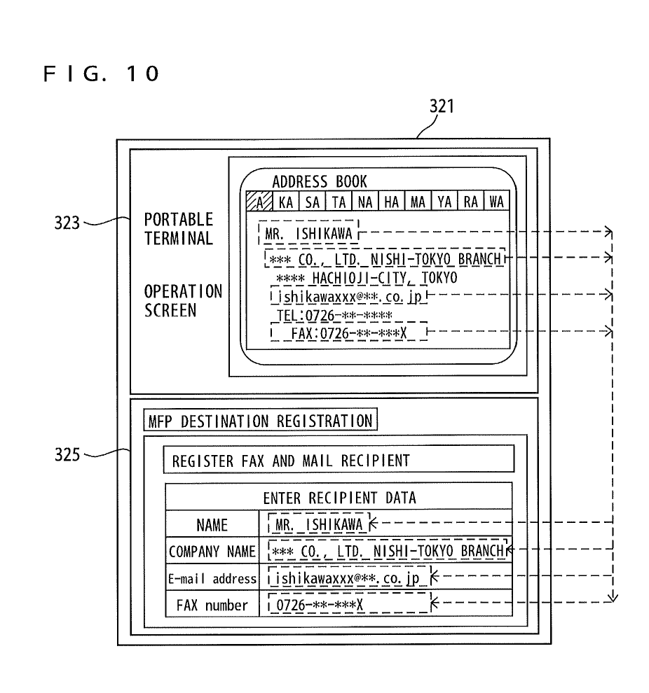

FIG. 10 is a diagram showing an example of a copy-and-paste operation. FIG. 10 shows a copy-and-paste operation in the case where portable information apparatus 200 is a client. Referring to FIG. 10, on a display surface 321 of display unit 216 of portable information apparatus 200, a second self-operation screen 323 is arranged in the upper region, and a first remote operation screen 325 is arranged in the lower region.

Second self-operation screen 323 is a screen for displaying the address data of the user named “Ishikawa” registered in an address book. Here, the name, company name, postal address, email address, telephone number, and facsimile number of the user named “Ishikawa” are displayed.

First remote operation screen 325 is a registration screen for registration in an address book. First remote operation screen 325 includes regions for inputting name, company name, email address, and facsimile number as address data.

The character string of the name displayed in second self-operation screen 323 is copied, and the region for inputting a name in first remote operation screen 325 is designated. Then, the copied character string of the name is entered in the region for inputting a name in first remote operation screen 325. Similarly, for the company name, email address, and facsimile number, the character string displayed in second self-operation screen 323 is copied, and the corresponding region in first remote operation screen 325 is designated. Then, the copied character string is entered in the input region included in first remote operation screen 325.

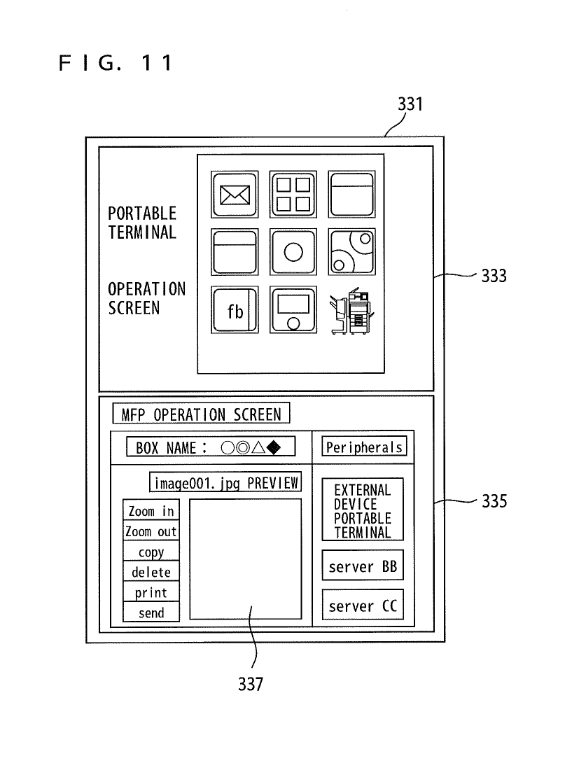

FIG. 11 is a diagram showing an example of the specific operation. FIG. 11 shows the specific operation in the case where portable information apparatus 200 is a client. Referring to FIG. 11, on a display surface 331 of display unit 216 of portable information apparatus 200, a second self-operation screen 333 is arranged in the upper region, and a first remote operation screen 335 is arranged in the lower region.

First remote operation screen 335 includes a preview image 337. The user performs a pinch-out operation of designating preview image 337 with the two fingers and widening the distance between the two fingers, so that an enlargement operation is input as a specific operation. The specific operation information is then transmitted to MFP 100. Accordingly, MFP 100 transmits a new first remote operation screen including the enlarged image of preview image 337. Thus, first remote operation screen 335 switches to a new first remote operation screen including the enlarged image. Therefore, MFP 100 can be remotely operated with a specific operation that can be input to portable information apparatus 200 but cannot be input to MFP 100.

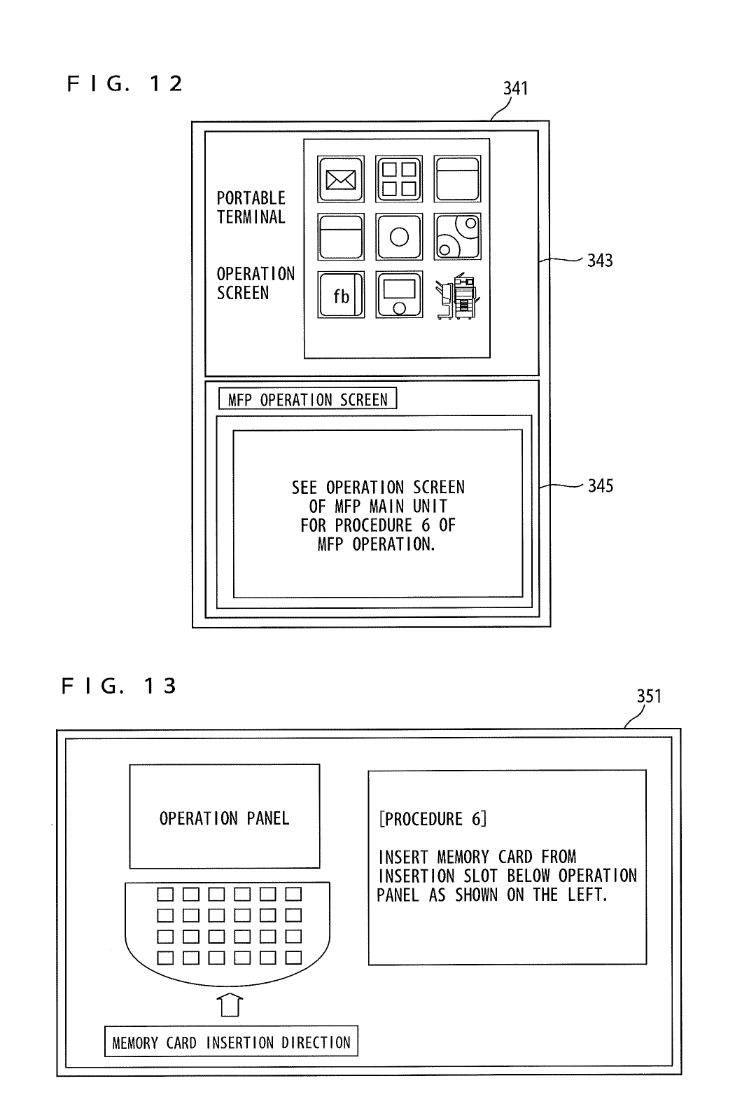

FIG. 12 is a diagram showing an example of the first alternative screen. Referring to FIG. 12, on a display surface 341 of display unit 216 of portable information apparatus 200, a second self-operation screen 343 is arranged in the upper region, and a first remote operation screen 345 is arranged in the lower region.

First remote operation screen 345 is the first alternative screen. Here, the first alternative screen includes a message “See the operation screen on the MFP main unit for the procedure 6 of MFP operation.” Therefore, when operating portable information apparatus 200, the user can be prompted to see display unit 161 of MFP 100.

FIG. 13 is a diagram showing an example of the first specific operation screen. Here, an example of the first specific operation screen is shown which is displayed when MFP 100 transmits the first alternative screen shown in FIG. 12 to portable information apparatus 200. Referring to FIG. 13, on a display surface 351 of display unit 161 of MFP 100, an image showing operation panel 160 is arranged on the left side with a character string “Memory Card Insertion Direction” and an arrow indicating the insertion direction toward the image of operation panel 160. A message “[Procedure 6] Insert memory card from the slot below operation panel as shown on the left” is arranged on the right side of display surface 351. Therefore, the user can be notified of the operation of inserting a memory card. In the case of an operation at a position close to operation panel 160, display on the display unit 161 of operation panel 160 eliminates the need for moving the point of view and makes the operation easier when compared with display of the first remote operation screen at portable information apparatus 200.

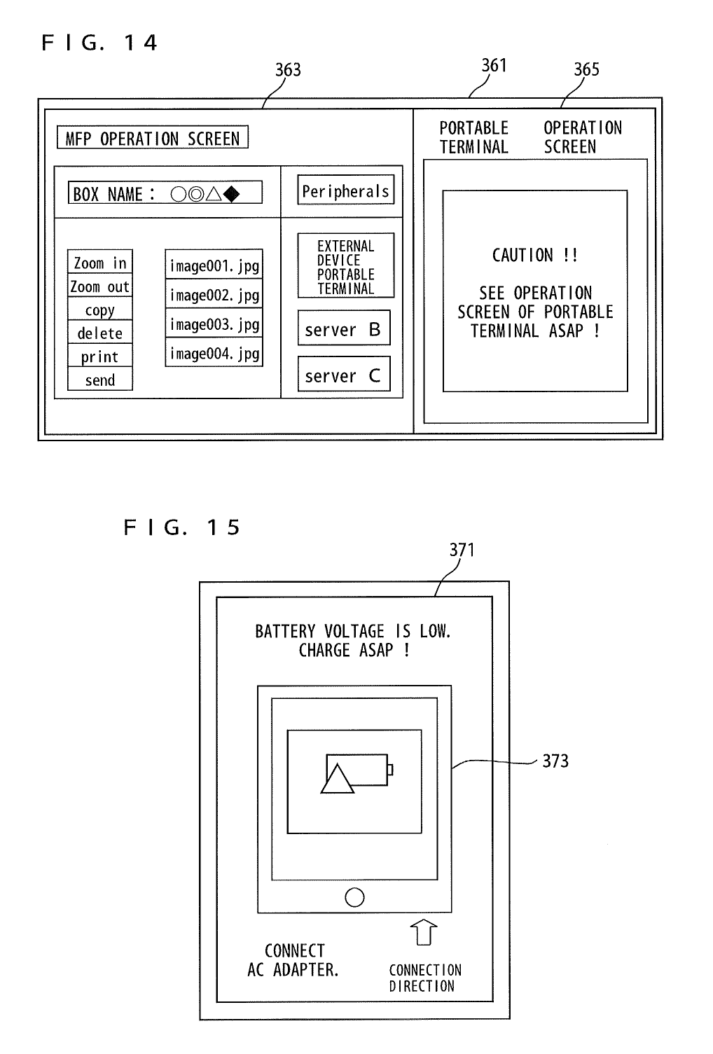

FIG. 14 is a diagram showing an example of the second alternative screen. Referring to FIG. 14, on a display surface 361 of display unit 161 of MFP 100, a first self-operation screen 363 is arranged in the left region, and a second remote operation screen 365 is arranged in the right region.

Second remote operation screen 365 is the second alternative screen. Here, the second alternative screen includes a message “Caution!! See the operation screen of the portable information apparatus ASAP!!” Therefore, when operating MFP 100, the user can be prompted to see display unit 216 of portable information apparatus 200.

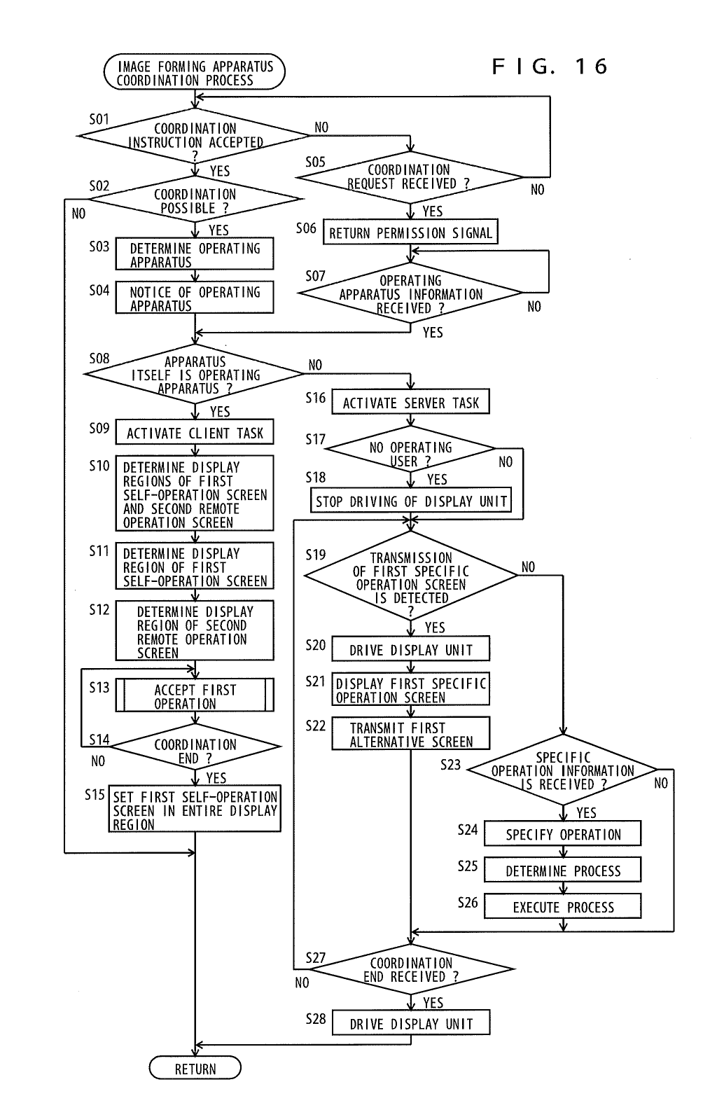

FIG. 15 is a diagram showing an example of the second specific operation screen. Here, an example of the second specific operation screen is shown in the case where portable information apparatus 200 transmits the second alternative screen shown in FIG. 14 to MFP 100. Referring to FIG. 15, on a display surface 371 of display unit 216 of portable information apparatus 200, an image 373 showing the appearance of portable information apparatus 200 is arranged. A message “Battery voltage is low. Charge ASAP!” is arranged above image 373. A message “Connect AC adapter,” a massage “Connection Direction,” and an arrow indicating the connection direction toward the lower right of image 373 of the appearance of portable information apparatus 200 are arranged below image 373. Therefore, the user can be notified that charging of portable information apparatus 200 is required and of the operation of inserting an AC adapter in order to do so. In the case of an operation of connecting external equipment to portable information apparatus 200, display on display unit 216 of portable information apparatus 200 eliminates the need for moving the point of view and thus makes the operation easier when compared with display of the second remote operation screen at MFP 100.

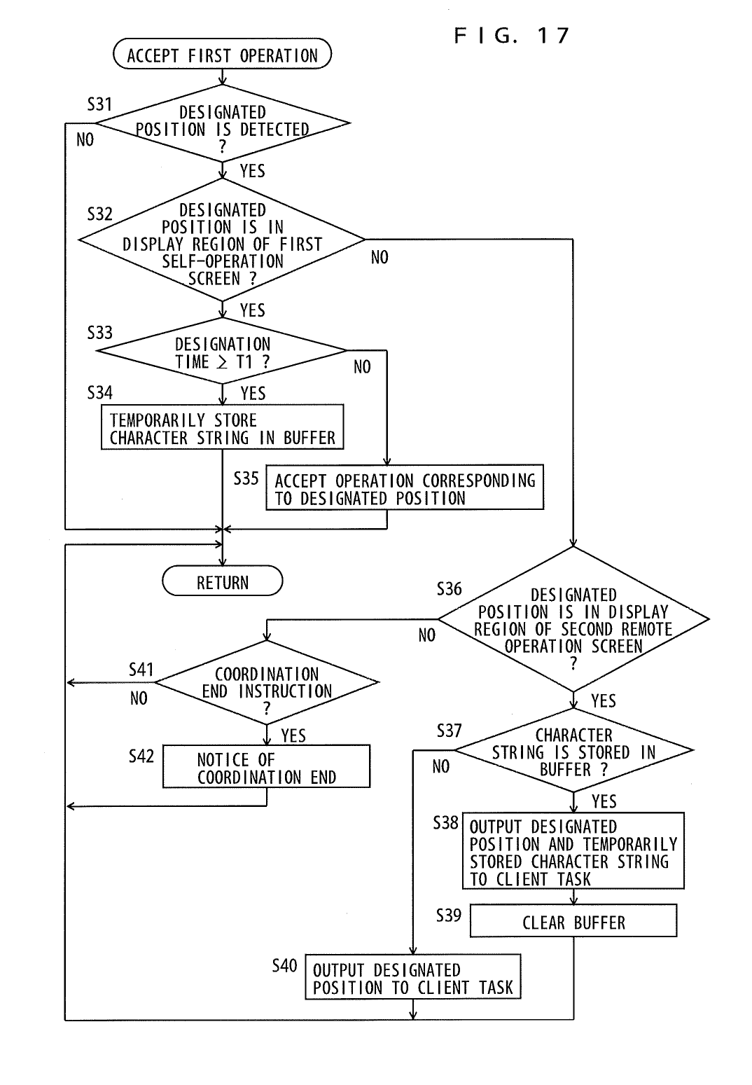

FIG. 16 is a flowchart showing an exemplary flow of an image processing apparatus coordination process. The image processing apparatus coordination process is a process executed by CPU 111 by CPU 111 of MFP 100 executing an image processing apparatus coordination program stored in ROM 113, EEPROM 115, HDD 116, or CD-ROM 119A. Referring to FIG. 16, CPU 111 determines whether a coordination instruction is accepted. The coordination instruction is accepted when the user designates a key in operation unit 163 to which a coordination instruction is allocated in advance. If the coordination instruction is accepted, the process proceeds to step S02. If not, the process proceeds to step S05.

In step S02, it is determined whether it is possible to coordinate with portable information apparatus 200. The network address of portable information apparatus 200 as the other party to coordinate with is stored beforehand. A coordination request for asking portable information apparatus 200 whether coordination is possible is transmitted using the network address. If a permission signal is returned from portable information apparatus 200, it is determined that coordination is possible. If coordination is possible, the process proceeds to step S03. If not, the process ends. In this case, for example, a message may be displayed on display unit 161 to notify the user that coordination is impossible.

Network addresses of a plurality of portable information apparatuses that can be coordinated may be stored beforehand. A list of the respective apparatus identification information of a plurality of portable information apparatuses may be displayed so that it is determined whether it is possible to communicate with the portable information apparatus of the apparatus identification information selected by the user. Alternatively, an inquiry signal may be transmitted by broadcast to search for communicable portable information apparatuses. Then, a list of apparatus identification information of one or more communicable portable information apparatuses detected by the search may be displayed so that the portable information apparatus of the apparatus identification information selected by the user is specified as an apparatus that can be coordinated.

In step S03, the operating apparatus is decided. The process then proceeds to step S04. Of portable information apparatus 200 and MFP 100, the apparatus designated by the user is decided as the operating apparatus serving as a client. Specifically, the coordination setting screen shown in FIG. 6 is displayed on display unit 161, and it is determined which of the check box for selecting portable information apparatus 200 as a client and the check box for selecting MFP 100 as a client is designated. If the check box for selecting portable information apparatus 200 as a client is designated, portable information apparatus 200 is decided as the operating apparatus. If the check box for selecting MFP 100 as a client is designated, MFP 100 is decided as the operating apparatus.

In step S04, portable information apparatus 200 to coordinate with is notified of the operating apparatus. The process then proceeds to step S08. Specifically, operating apparatus information including the apparatus identification information of the operating apparatus decided in step S03 is transmitted to portable information apparatus 200 through communication I/F unit 112.

On the other hand, in step S05, it is determined whether a coordination request is received. If communication I/F unit 112 externally receives a coordination request, the process proceeds to step S06. If not, the process returns to step S01. In step S06, the apparatus that has transmitted the coordination request is specified, and a permission signal indicating that coordination is possible is returned to the specified apparatus. In the next step S07, it is determined whether the operating apparatus information is received. For example, if a coordination request is received from portable information apparatus 200, the user of portable information apparatus 200 decides which of portable information apparatus 200 and MFP 100 is to be set as the operating apparatus. Portable information apparatus 200 transmits the operating apparatus information including the apparatus identification information for identifying the operating apparatus decided by the user. CPU 111 controls communication I/F unit 112 to receive the operating apparatus information from portable information apparatus 200. The process waits until the operating apparatus information is received. If the operating apparatus information is received, the process proceeds to step S08.

In step S08, it is determined whether the MFP itself is the operating apparatus. If the MFP itself is the operating apparatus, the process proceeds to step S09. If not, the process proceeds to step S16. In step S09, a client task is activated. Specifically, a client program stored in ROM 113, EEPROM 115, HDD 116, or CD-ROM 119A is executed. In doing so, the network address of portable information apparatus 200 serving as a server, for example, the IP (Internet Protocol) address is passed as an argument to the client task. At this stage, the client task receives the second remote operation screen from portable information apparatus 200.

In the next step S10, the respective display regions of the first self-operation screen and the second remote operation screen are determined. The display regions in the display surface of display unit 161 are determined. The first self-operation screen is an operation screen for operating MFP 100. The second remote operation screen is an operation screen received by the client task from portable information apparatus 200 for remotely operating portable information apparatus 200. In step S11, the display region determined for the first self-operation screen in step S10 is set as a region for displaying the first self-operation screen. In step S12, the display region determined for the second remote operation screen in step S10 is set as a region for displaying the second remote operation screen output by the client task activated in step S09.

In the next step S13, a first operation accepting process is executed. The process then proceeds to step S14. The details of the first operation accepting process will be described later. In step S14, it is determined whether a coordination end instruction is accepted. The coordination end instruction is accepted if the user designates a key in operation unit 163 to which a coordination end instruction is allocated. Alternatively, the coordination end instruction is accepted when communication I/F unit 112 receives a coordination end signal from portable information apparatus 200. If the coordination end instruction is accepted, the process proceeds to step S15. If not, the process returns to step S13. In step S15, the display region of the first self-operation screen is set in the entire region of the display surface of display unit 161. The process then ends.

On the other hand, in step S16, a server task is activated. Specifically, a server program stored in ROM 113, EEPROM 115, HDD 116, or CD-ROM 119A is executed. At this stage, the server task communicates with portable information apparatus 200 serving as a client, transmits the first self-operation screen as the first remote operation screen to portable information apparatus 200, and executes a process in accordance with the operation received from portable information apparatus 200.

In the next step S17, it is determined whether an operating user is present. It is determined whether the user who operates operation unit 163 is present. If there exists a user who operates operation unit 163 to log into MFP 100, it is determined that an operating user is present. If no operating user is present, the process proceeds to step S18. If an operating user is present, step S18 is skipped, and the process proceeds to step S19. In step S18, driving of display unit 161 is stopped. Here, electric power supplied to display unit 161 is cut off. This is to prevent display unit 161 from consuming power and to reduce power consumption. In place of cutting off electric power, power consumed by display unit 161 may be reduced. If an operating user is present, step S18 is not executed, so that the first self-operation screen appears on the entire screen of display unit 161. This allows the operating user to perform an operation in accordance with the first self-operation screen.

In the next step S19, it is determined whether transmission of the first specific operation screen is detected. The first remote operation screen transmitted to portable information apparatus 200 by the server task activated in step S16 is monitored, and it is determined whether the transmitted first remote operation screen is the first specific operation screen. If transmission of the first specific operation screen is detected, the process proceeds to step S20. If not, the process proceeds to step S23.

In step S20, display unit 161 that is stopped being driven in step S18 is driven. In the next step S21, the first specific operation screen is displayed on display unit 161. The process then proceeds to step S22. In step S22, the first alternative screen is transmitted to portable information apparatus 200. The process then proceeds to step S27. When the server task transmits the first specific operation screen, transmission of the first specific operation screen is stopped before the first specific operation screen is transmitted, and the first alternative screen is transmitted to portable information apparatus 200, in place of the first specific operation screen. Accordingly, at portable information apparatus 200, the first specific operation screen is not displayed but the first alternative screen is displayed.

On the other hand, in step S23, it is determined whether the specific operation information is received. It is determined whether communication I/F unit 112 receives the specific operation information from portable information apparatus 200. If the specific operation information is received, the process proceeds to step S24. If not, the process proceeds to step S27. The specific operation information includes positional information indicating a position in the first self-operation screen transmitted as the first remote operation screen by the server task, and the amount of change.

In step S24, the operation is specified based on the specific operation information. Specifically, of operations that can be input to the first self-operation screen, an operation allocated at a position in the first self-operation screen as specified by the positional information included in the specific operation information, or an operation corresponding to an image at a position in the first self-operation screen as specified by the positional information included in the specific operation information, with designation of the amount of change, is specified. For example, when the position in the first self-operation screen as specified by the positional information included in the specific operation information is in an image, an operation of enlarging the image or an operation of reducing is specified. If the amount of change is positive, the operation of enlarging is specified. If the amount of change is negative, the operation of reducing is specified. When the position in the first self-operation screen as specified by the positional information included in the specific operation information is in a region for inputting a parameter, an operation of increasing the parameter or an operation of reducing the parameter is specified.

Then, the process corresponding to the operation specified in step S24 is determined (step S25), and the determined process is executed (step S26). The process then proceeds to step S27. For example, in a case where the first self-operation screen includes an image and the specific operation information includes positional information indicating the position in the image and a positive amount of change, a process of enlarging the image in the first self-operation screen is executed, and the server task transmits the first self-operation screen with the enlarged image as a new first remote operation screen to portable information apparatus 200. This allows the user using portable information apparatus 200 to input an operation of enlarging the image in the first self-operation screen using the operation function included in portable information apparatus 200.

In step S27, it is determined whether a coordination end instruction is accepted. The coordination end instruction is accepted when communication I/F unit 112 receives a coordination end signal from portable information apparatus 200. If the coordination end instruction is accepted, the process proceeds to step S28. If not, the process returns to step S19. In step S28, display unit 161 that is stopped being driven in step S18 is driven. The process then ends.

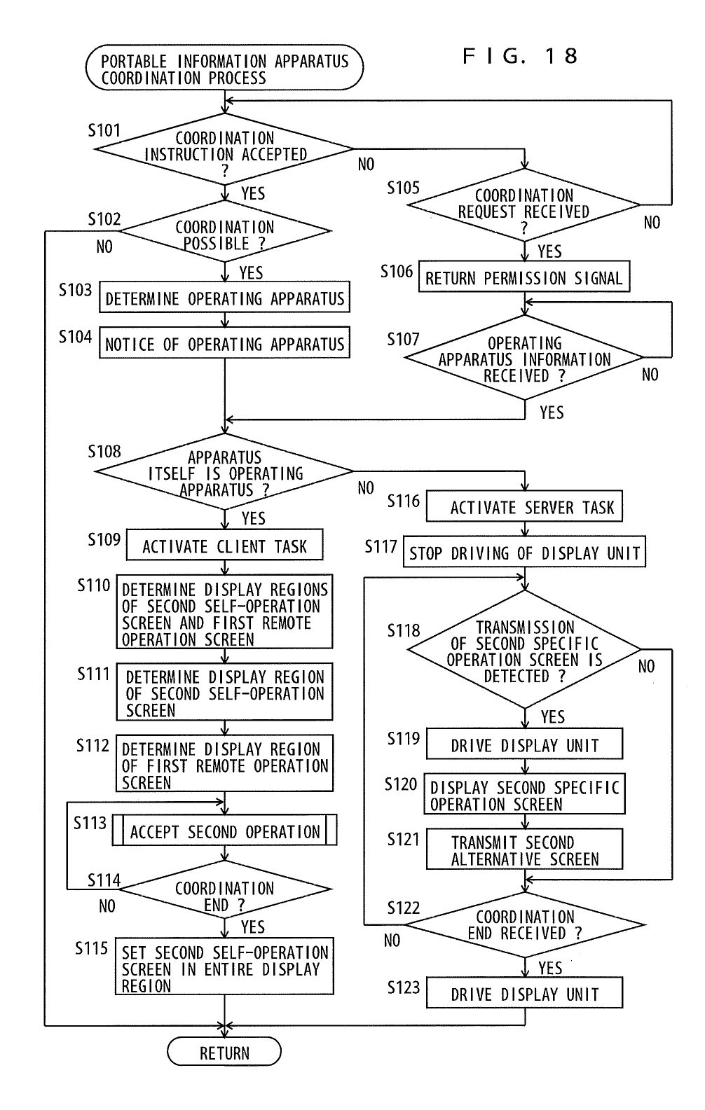

FIG. 17 is a flowchart showing an exemplary flow of the first operation accepting process. The first operation accepting process is a process executed in step S13 of the image processing apparatus coordination process shown in FIG. 16. Referring to FIG. 17, CPU 111 determines whether a designated position is detected (step S31). If positional information is input from touch panel 165, the position specified by the coordinate value included in the positional information is detected as the designated position. If the designated position is detected, the process proceeds to step S32. If not, the process returns to the image processing apparatus coordination process.

In step S32, it is determined whether the designated position is in the display region of the first self-operation screen. The display region of the first self-operation screen is a region in the display surface of display unit 161 that is set in step S11 in FIG. 16. If the designated position is in the display region of the first self-operation screen, the process proceeds to step S33. If not, the process proceeds to step S36.

In step S33, it is determined whether the designation time during which the designated position is detected is equal to or longer than the threshold value T1. If the designation time is equal to or longer than the threshold value T1, the operation is determined as designating copy, and the process proceeds to step S34. If not, the process proceeds to step S35. In step S34, the character string arranged in the vicinity of the designated position in the first self-operation screen is temporarily stored in the buffer. The process then returns to the image processing apparatus coordination process. A temporal change of the designated position may be detected, and the character string included in the region specified by the changing designated position may be specified as a character string to be temporarily stored. In step S35, the operation corresponding to the designated position is accepted. The process then returns to the image processing apparatus coordination process.

On the other hand, in step S36, it is determined whether the designated position is in the display region of the second remote operation screen. The display region of the second remote operation screen is a region in the display surface of display unit 161 that is set in step S12 in FIG. 16. If the designated position is in the display region of the second remote operation screen, the process proceeds to step S37. If not, the process proceeds to step S41.

In step S37, it is determined whether step S34 is executed and a character string is stored in the buffer. If a character string is stored, the operation is determined as designating paste, and the process proceeds to step S38. If not, the process proceeds to step S40. In step S38, the character string is read out from the buffer, and the designated position and the character string are output to the client task. In the client task, it is determined that the character string is entered in the designated position, and the operation in which the character string is entered in the designated position is transmitted to portable information apparatus 200 as a server. Thus, the character string can be entered in the second remote operation screen with a simple operation of copying the character string included in the first self-operation screen and pasting it in the input region in the second remote operation screen. In the next step S39, the buffer is cleared. The process then returns to the image processing apparatus coordination process.

In step S40, the designated position is output to the client task. The process then returns to the image processing apparatus coordination process. The client task transmits the operation of designating the designated position to portable information apparatus 200 as a server. Then, portable information apparatus 200 detects that the designated position in the second self-operation screen that is the second remote operation screen is designated, and accepts a remote operation.

In step S41, it is determined whether a coordination end instruction is accepted. The coordination end instruction is accepted if the designated position is in a region of the key to which an instruction to terminate the coordination process is allocated. If the coordination end instruction is accepted, the process proceeds to step S42. If not, the process returns to the image processing apparatus coordination process. In step S42, a notice of coordination end is given to portable information apparatus 200 as a client. The process then returns to the image processing apparatus coordination process. Specifically, a coordination end signal is transmitted to portable information apparatus 200 through communication I/F unit 112.

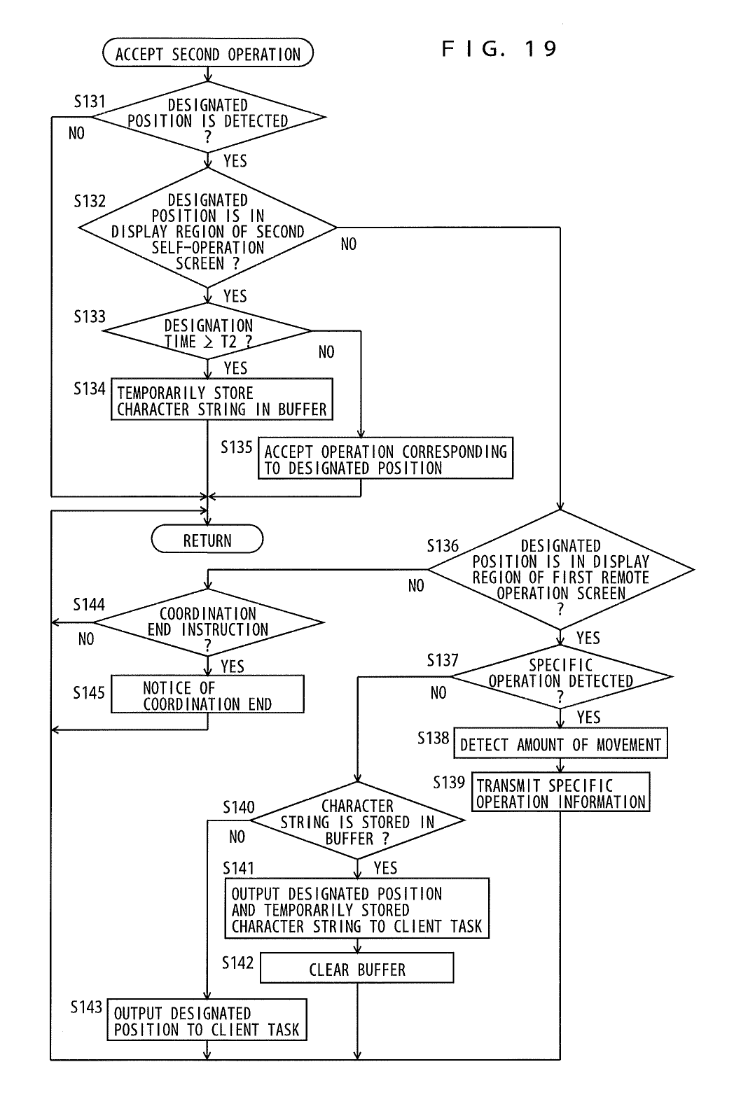

FIG. 18 is a flowchart showing an exemplary flow of the portable information apparatus coordination process. The portable information apparatus coordination process is a process executed by CPU 211 by CPU 211 of portable information apparatus 200 executing a portable information apparatus coordination program stored in flash memory 213. Referring to FIG. 18, CPU 211 determines whether a coordination instruction is accepted (step S101). If the coordination instruction is accepted, the process proceeds to step S102. If not, the process proceeds to step S105. In step S102, it is determined whether it is possible to coordinate with MFP 100 that is the other party to coordinate with. If coordination is possible, the process proceeds to step S103. If not, the process ends. In step S103, the operating apparatus is decided. The process then proceeds to step S104. Of portable information apparatus 200 and MFP 100, the apparatus that is designated by the user is decided as the operating apparatus serving as a client. In step S104, MFP 100 to coordinate with is notified of the operating apparatus. The process then proceeds to step S108. Specifically, operating apparatus information including the apparatus identification information of the operating apparatus decided in step S103 is transmitted to MFP 100 through wireless LAN I/F 218.

On the other hand, in step S105, it is determined whether a coordination request is received. If wireless LAN I/F 218 externally receives a coordination request, the process proceeds to step S106. If not, the process returns to step S101. In step S106, the apparatus that has transmitted the coordination request is specified, and a permission signal indicating coordination is possible is returned to the specified apparatus. The process then proceeds to step S107. In step S107, the process waits until the operating apparatus information is received. If the operating apparatus information is received, the process proceeds to step S108.

In step S108, it is determined whether the portable information apparatus itself is the operating apparatus. If the portable information apparatus itself is the operating apparatus, the process proceeds to step S109. If not, the process proceeds to step S116. In step S109, a client task is activated. At this stage, the client task receives the first remote operation screen from MFP 100.

In the next step S110, the respective display regions of the second self-operation screen and the first remote operation screen are determined. The display regions in the display surface of display unit 216 are determined. The second self-operation screen is an operation screen for operating portable information apparatus 200. The first remote operation screen is an operation screen received by the client task from MFP 100 for remotely operating MFP 100. In step S111, the display region determined for the second self-operation screen in step S110 is set as a region for displaying the second self-operation screen. In step S112, the display region determined for the first remote operation screen in step S110 is set as a region for displaying the first remote operation screen output by the client task activated in step S109.

In the next step S113, a second operation accepting process is executed. The process then proceeds to step S114. The details of the second operation accepting process will be described later. In step S114, it is determined whether a coordination end instruction is accepted. The coordination end instruction is accepted if the user designates a key in operation unit 217 to which a coordination end instruction is allocated. Alternatively, the coordination end instruction is accepted when wireless LAN I/F 218 receives a coordination end signal from MFP 100. If the coordination end instruction is accepted, the process proceeds to step S115. If not, the process returns to step S113. In step S115, the display region of the second self-operation screen is set in the entire region of the display surface of display unit 216. The process then ends.

On the other hand, in step S116, a server task is activated. At this stage, the server task communicates with MFP 100 serving as a client, transmits the second self-operation screen as the second remote operation screen to MFP 100, and executes a process in accordance with the operation received from MFP 100.

In the next step S117, driving of display unit 216 is stopped. Here, electric power supplied to display unit 216 is cut off. This is to prevent display unit 216 from consuming power and to reduce power consumption. In place of cutting off electric power, power consumed by display unit 216 may be reduced. In the next step S118, it is determined whether transmission of the second specific operation screen is detected. The second remote operation screen transmitted to MFP 100 by the server task activated in step S116 is monitored, and it is determined whether the transmitted second remote operation screen is the second specific operation screen. If transmission of the second specific operation screen is detected, the process proceeds to step S119. If not, the process proceeds to step S122.

In step S119, display unit 216 that is stopped being driven in step S117 is driven. In the next step S120, the second specific operation screen is displayed on display unit 216. The process then proceeds to step S121. In step S121, the second alternative screen is transmitted to MFP 100. The process then proceeds to step S122. When the server task transmits the second specific operation screen, transmission of the second specific operation screen is stopped before the second specific operation screen is transmitted, and the second alternative screen is transmitted to MFP 100, in place of the second specific operation screen. Accordingly, at MFP 100, the second specific operation screen is not displayed but the second alternative screen is displayed.

In step S122, it is determined whether a coordination end instruction is accepted. The coordination end instruction is accepted when wireless LAN I/F 218 receives a coordination end signal from MFP 100. If the coordination end instruction is accepted, the process proceeds to step S123. If not, the process returns to step S118. In step S123, display unit 216 that is stopped being driven in step S117 is driven. The process then ends.

FIG. 19 is a flowchart showing an exemplary flow of the second operation accepting process. The second operation accepting process is a process executed in step S113 of the portable information apparatus coordination process shown in FIG. 18. Referring to FIG. 19, CPU 211 determines whether a designated position is detected (step S131). If positional information is input from touch panel 217A, the coordinate value included in the positional information is detected as the designated position. If the designated position is detected, the process proceeds to step S132. If not, the process returns to the portable information apparatus coordination process.

In step S132, it is determined whether the designated position is in the display region of the second self-operation screen. The display region of the second self-operation screen is a region in the display surface of display unit 216 that is set in step S111 in FIG. 18. If the designated position is in the display region of the second self-operation screen, the process proceeds to step S133. If not, the process proceeds to step S136.

In step S133, it is determined whether the designation time during which the designated position is detected is equal to or longer than the threshold value T2. If the designation time is equal to or longer than the threshold value T2, the operation is determined as designating copy, and the process proceeds to step S134. If not, the process proceeds to step S135. In step S134, the character string arranged in the vicinity of the designated position in the second self-operation screen is temporarily stored in the buffer. The process then returns to the portable information apparatus coordination process. A temporal change of the designated position may be detected, and the character string included in the region specified by the changing designated position may be specified as a character string to be temporarily stored. In step S135, the operation corresponding to the designated position is accepted. The process then returns to the portable information apparatus coordination process.

On the other hand, in step S136, it is determined whether the designated position is in the display region of the first remote operation screen. The display region of the first remote operation screen is a region in the display surface of display unit 216 that is set in step S112 in FIG. 18. If the designated position is in the display region of the first remote operation screen, the process proceeds to step S137. If not, the process proceeds to step S144.

In step S137, it is determined whether a specific operation is detected. The specific operation is detected if a plurality of designated positions are detected in step S131. If a specific operation is detected, the process proceeds to step S138. If not, the process proceeds to step S140. In step S138, the amount of change is detected based on a temporal change of a plurality of designated positions detected. The specific operation includes an enlargement operation and a reduction operation. The change amount D is obtained from a distance L1 between two designated positions at a first time and a distance L2 between two designated positions at a second time later than the first time. The change amount D is a value obtained by subtracting distance L1 from distance L2. If the change amount D is positive, the operation is an enlargement operation. If negative, it is a reduction operation. The first time is a time when the designated position is initially detected, and the second time is a time when a designated position is no longer detected or the distance between two designated position stops being changed.

In step S139, the specific operation information is transmitted to MFP 100 through wireless LAN I/F 218. The process then returns to the portable information apparatus coordination process. The specific operation information includes a set of a coordinate value of one of a plurality of designated positions detected in step S131 and the amount of change detected in step S138.

In step S140, it is determined whether step S134 is executed and a character string is stored in the buffer. If a character string is stored, the operation is determined as designating paste, and the process proceeds to step S141. If not, the process proceeds to step S143. In step S141, the character string is read out from the buffer, and the designated position and the character string are output to the client task. In the client task, it is determined that the character string is entered in the designated position, and the operation in which the character string is entered in the designated position is transmitted to MFP 100 as a server. Thus, the character string can be entered in the first remote operation screen with a simple operation of copying the character string included in the second self-operation screen and pasting it in the input region in the first remote operation screen. In the next step S142, the buffer is cleared. The process then returns to the portable information apparatus coordination process.

In step S143, the designated position is output to the client task. The process then returns to the portable information apparatus coordination process. The client task transmits the operation of designating the designated position to MFP 100 as a server. Then, MFP 100 detects that the designated position in the first self-operation screen that is the first remote operation screen is designated, and accepts a remote operation.

In step S144, it is determined whether a coordination end instruction is accepted. The coordination end instruction is accepted if the designated position is in a region of a key to which an instruction to terminate the coordination process is allocated. If the coordination end instruction is accepted, the process proceeds to step S145. If not, the process returns to the portable information apparatus coordination process. In step S145, a notice of coordination end is given to MFP 100 as a client. The process then returns to the portable information apparatus coordination process. Specifically, a coordination end signal is transmitted to MFP 100 through wireless LAN I/F 218.

As described above, MFP 100 functions as an image processing apparatus and can function as a server as well as a client. When MFP 100 functions as a server, display unit 161 is switched to the power saving mode, thereby reducing power consumption when functioning as a server. When MFP 100 functions as a client, the first self-operation screen and the second remote operation screen are simultaneously displayed on display unit 161. Therefore, when functioning as a client, MFP 100 can operate itself and portable information apparatus 200.

MFP 100 selects one of the first state in which first server portion 59, which is a task executing the server program, can communicate with portable information apparatus 200 and the second state in which first client portion 61, which is a task executing the client program, can communicate with portable information apparatus 200. This allows one of MFP 100 and portable information apparatus 200 to function as a server and allows the other to function as a client.

When functioning as a client, MFP 100 temporarily stores a character string included in the first self-operation screen and outputs the temporarily stored character string and the positional information indicating the position designated by the user in the second remote operation screen to first client portion 61. Therefore, when MFP 100 functions as a client, the character string included in the first self-operation screen can be entered in the position designated by the user in the second remote operation screen.

When functioning as a server, MFP 100 determines a process for the specific operation based on the specific operation information and the second remote operation screen, in response to reception of the specific operation information including the positional information indicating the position in the remote operation screen transmitted to portable information apparatus 200 functioning as a client, and the amount of change, from portable information apparatus 200, and executes the determined process. Therefore, even when a specific operation different from an operation that can be input to MFP 100 is input to portable information apparatus 200, the specific operation can be transformed into an operation that can be input to MFP 100. As a result, the function of portable information apparatus 200 can be effectively utilized.

When MFP 100 functions as a server, if the first remote operation screen to be transmitted to portable information apparatus 200 functioning as a client is a predetermined first specific screen, MFP 100 transmits another first alternative screen in place of the first remote operation screen, switches display unit 161 to the normal mode, and displays the first remote operation screen on display unit 161. Therefore, when functioning as a server, MFP 100 displays the first specific screen and allows portable information apparatus 200 to display the first alternative screen. As a result, the user can be notified that the user is requested to operate MFP 100.

On the other hand, portable information apparatus 200 can function as a server as well as a client. When portable information apparatus 200 functions as a server, display unit 216 is switched to the power saving mode, thereby reducing power consumption when functioning as a server. When functioning as a client, the second self-operation screen and the first remote operation screen are simultaneously displayed on display unit 216. Therefore, when functioning as a client, portable information apparatus 200 can operate itself and MFP 100.

Portable information apparatus 200 selects one of the first state in which second server portion 259 executing the server program can communicate with MFP 100 and the second state in which second client portion 261 executing the client program can communicate with MFP 100. This allows one of MFP 100 and portable information apparatus 200 to function as a server and allows the other to function as a client.

When functioning as a client, portable information apparatus 200 temporarily stores a character string included in the second self-operation screen and outputs the temporarily stored character string and the positional information indicating the position designated by the user in the first remote operation screen to second client portion 261. Therefore, when portable information apparatus 200 functions as a client, the character string included in the second self-operation screen can be entered in the position designated by the user in the first remote operation screen.

When portable information apparatus 200 functions as a server, if the second remote operation screen is a second specific screen, portable information apparatus 200 transmits another second alternative screen in place of the second remote operation screen and displays the second remote operation screen on display unit 216. Therefore, when functioning as a server, portable information apparatus 200 displays the second specific screen and allows MFP 100 to display the second alternative screen. As a result, the user can be notified that the user is requested to operate portable information apparatus 200.

Image processing system 1 has been described in the foregoing embodiment. However, it is needless to say that the present invention can be understood as an image processing apparatus coordination method allowing each of MFPs 100, 100A, and 100B to execute the image processing apparatus coordination process shown in FIG. 16 and FIG. 17, and an image processing apparatus coordination program allowing CPU 111 of each of MFPs 100, 100A, and 100B to execute the image processing apparatus coordination method, as well as a portable information apparatus coordination method allowing portable information apparatus 200 to execute the portable information apparatus coordination process shown in FIG. 18 and FIG. 19, and a portable information apparatus coordination program allowing CPU 211 of portable information apparatus 200 to execute the portable information apparatus coordination method.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An image processing system that allows mutual remote operation with a client remotely operating one of an image processing apparatus and a portable information apparatus and with a server being remotely operated by the other,
each of said image processing apparatus and said portable information apparatus comprising:
a display portion to display an image;
a switch portion to switch said display portion to a power saving mode in which power consumption is smaller than in a normal mode, when functioning as said server, and to switch said display portion to said normal mode, when functioning as said client; and
a display control portion to simultaneously display a self-operation screen for operating the apparatus itself and a remote operation screen for remotely operating said server on said display portion, when functioning as said client.

2. The image processing system according to claim 1, wherein each of said image processing apparatus and said portable information apparatus further comprises:
a server portion to communicate with an apparatus functioning as said client and to function as a server being remotely controlled by the apparatus functioning as said client; and
a client portion to communicate with an apparatus functioning as said server and to function as a client remotely controlling said server.

3. The image processing system according to claim 2, wherein each of said image processing apparatus and said portable information apparatus further comprises a select portion to select one of a first state in which said server portion can communicate with an apparatus functioning as said client and a second state in which said client portion can communicate with an apparatus functioning as said server.

4. The image processing system according to claim 2, wherein, when functioning as said client, each of said image processing apparatus and said portable information apparatus further comprises:
a temporary storage portion to temporarily store a character string included in said self-operation screen;
a designated position accepting portion to accept a position designated by the user in said remote operation screen as a designated position; and
an output portion to output said temporarily stored character string and positional information indicating said designated position to said client portion.

5. The image processing system according to claim 1, wherein
said portable information apparatus further comprises:
a position detection portion to detect a position designated by a user on a display surface of said display unit of said portable information apparatus;
when functioning as said client, a specific operation detection portion to detect a specific operation for said image processing apparatus functioning as said server, based on a temporal change of a position in said remote operation screen as detected by said position detection portion; and
a specific operation transmission portion to transmit, to said image processing apparatus, specific operation information including an amount of change of said position and positional information indicating a position in said remote operation screen as determined by the position detected by said position detection portion, when said specific operation is detected, and
when functioning as said server, said image processing apparatus further comprises:
a specific operation reception portion to receive said specific operation information from said portable information apparatus functioning as said client;
a process determination portion to, in response to said specific operation being received, determine a process for said specific operation based on said received specific operation information and said remote operation screen transmitted to said portable information apparatus; and
a process execution portion to execute said determined process.

6. The image processing system according to claim 1, wherein
when functioning as said server, each of said image processing apparatus and said portable information apparatus further comprises a transmission portion to transmit another alternative screen in place of a remote operation screen when said remote operation screen to be transmitted to said client is a predetermined specific screen,
when said transmission portion transmits said alternative screen, said switch portion switches said display portion to said normal mode, and
when said transmission portion transmits said alternative screen, said display control portion displays said remote operation screen on said display unit.

7. An image processing apparatus comprising:
a display portion to display an image;
a communication portion to communicate with a portable information apparatus;
a server portion to communicate with said portable information apparatus and to function as a server being remotely operated by said portable information apparatus;
a client portion to communicate with said portable information apparatus and to function as a client remotely operating said portable information apparatus;
a switch portion to switch said display portion to a power saving mode in which power consumption is smaller than in a normal mode, when functioning as said server, and to switch said display portion to said normal mode, when functioning as said client; and
a display control portion to simultaneously display a self-operation screen for operating the image processing apparatus itself and a remote operation screen for remotely operating said portable information apparatus on said display portion, when functioning as said client.

8. The image processing apparatus according to claim 7, further comprising a select portion to select one of a first state in which said server potion can communicate with said portable information apparatus and a second state in which said client portion can communicate with said portable information apparatus.

9. The image processing apparatus according to claim 7, wherein, when functioning as said client, the image processing apparatus further comprises:
a temporary storage portion to temporarily store a character string included in said self-operation screen; and
an output portion to output said temporarily stored character string and positional information indicating a position designated by a user in said remote operation screen to said client portion.

10. The image processing apparatus according to claim 7, wherein, when functioning as said server, the image processing apparatus further comprises:
a specific operation reception portion to receive specific operation information including positional information indicating a position in said remote operation screen transmitted to said portable information apparatus functioning as said client, and an amount of change, from said portable information apparatus;
a process determination portion to, in response to said specific operation being received, determine a process corresponding to said specific operation, based on said received specific operation and said remote operation screen transmitted to said portable information apparatus; and
a process execution portion to execute said determined process.

11. The image processing apparatus according to claim 7, wherein
when functioning as said server, the image processing apparatus further comprises a transmission portion to transmit another alternative screen in place of a remote operation screen when said remote operation screen to be transmitted to said portable information apparatus functioning as said client is a predetermined specific screen,
when said transmission portion transmits said alternative screen, said switch portion switches said display portion to said normal mode, and
when said transmission portion transmits said alternative screen, said display control portion displays said remote operation screen on said display portion.

12. A portable information apparatus comprising:
a display portion to display an image;
a communication portion to communicate with an image processing apparatus;
a server portion to communicate with said image processing apparatus and to function as a server being remotely operated by said image processing apparatus;
a client portion to communicate with said image processing apparatus and to function as a client remotely operating said image processing apparatus;
a switch portion to switch said display portion to a power saving mode in which power consumption is smaller than in a normal mode, when functioning as said server, and to switch said display portion to said normal mode, when functioning as said client; and
a display control portion to simultaneously display a self-operation screen for operating the portable information apparatus itself and a remote operation screen for remotely operating said image processing apparatus on said display portion, when functioning as said client.

13. The portable information apparatus according to claim 12, further comprising a select portion to select one of a first state in which said server potion can communicate with said image processing apparatus and a second state in which said client portion can communicate with said image processing apparatus.

14. The portable information apparatus according to claim 12, wherein, when functioning as said client, the portable information apparatus further comprises:
a temporary storage portion to temporarily store a character string included in said self-operation screen; and
an output portion to output said temporarily stored character string and positional information indicating a position designated by a user in said remote operation screen to said client portion.

15. The portable information apparatus according to claim 12, wherein, when functioning as said server, the portable information apparatus further comprises a transmission portion to transmit another alternative screen in place of a remote operation screen when said remote operation screen to be transmitted to said image processing apparatus functioning as said client is a predetermined specific screen,
when said transmission portion transmits said alternative screen, said switch portion switches said display portion to said normal mode, and
when said transmission portion transmits said alternative screen, said display control portion displays said remote operation screen on said display portion.

16. An image processing apparatus coordination method performed in an image processing apparatus that coordinates with a portable information apparatus to accept an operation,
said image processing apparatus including
a display portion to display an image,
a communication portion to communicate with a portable information apparatus,
a server portion to communicate with said portable information apparatus and to function as a server being remotely operated by said portable information apparatus, and
a client portion to communicate with said portable information apparatus and to function as a client remotely operating said portable information apparatus,
said method comprising the steps of:
when functioning as said server, switching said display portion to a power saving mode in which power consumption is smaller than in a normal mode;
when functioning as said client, switching said display portion to said normal mode; and
when functioning as said client, simultaneously displaying a self-operation screen for operating the image processing apparatus itself and a remote operation screen for remotely operating said portable information apparatus on said display portion.

17. A portable information apparatus coordination method performed in a portable information apparatus that coordinates with an image processing apparatus to accept an operation,
said portable information apparatus including
a display portion to display an image,
a communication portion to communicate with an image processing apparatus,
a server portion to communicate with said image processing apparatus and to function as a server being remotely operated by said image processing apparatus, and
a client portion to communicate with said image processing apparatus and to function as a client remotely operating said image processing apparatus,
said method comprising the steps of:
when functioning as said server, switching said display portion to a power saving mode in which power consumption is smaller than in a normal mode;
when functioning as said client, switching said display portion to said normal mode; and
when functioning as said client, simultaneously displaying a self-operation screen for operating the portable information apparatus itself and a remote operation screen for remotely operating said image processing apparatus on said display portion.

18. A non-transitory computer-readable recording medium encoded with an image processing apparatus coordination program executed by a computer, said computer controlling an image processing apparatus that coordinates with a portable information apparatus to accept an operation,
said image processing apparatus including
a display portion to display an image,
a communication portion to communicate with a portable information apparatus,
a server portion to communicate with said portable information apparatus and to function as a server being remotely operated by said portable information apparatus, and
a client portion to communicate with said portable information apparatus and to function as a client remotely operating said portable information apparatus,
said program causing said computer to perform processing comprising the steps of:
when functioning as said server, switching said display portion to a power saving mode in which power consumption is smaller than in a normal mode;
when functioning as said client, switching said display portion to said normal mode; and
when functioning as said client, simultaneously displaying a self-operation screen for operating the image processing apparatus itself and a remote operation screen for remotely operating said portable information apparatus on said display portion.

19. A non-transitory computer-readable recording medium encoded with a portable information apparatus coordination program executed by a computer, said computer controlling a portable information apparatus that coordinates with an image processing apparatus to accept an operation,
said portable information apparatus including
a display portion to display an image,
a communication portion to communicate with an image processing apparatus,
a server portion to communicate with said image processing apparatus and to function as a server being remotely operated by said image processing apparatus, and
a client portion to communicate with said image processing apparatus and to function as a client remotely operating said image processing apparatus,
said program causing said computer to perform processing comprising the steps of:
when functioning as said server, switching said display portion to a power saving mode in which power consumption is smaller than in a normal mode;
when functioning as said client, switching said display portion to said normal mode; and
when functioning as said client, simultaneously displaying a self-operation screen for operating the portable information apparatus itself and a remote operation screen for remotely operating said image processing apparatus on said display portion.
